(19) United States
(12) Patent Application Publication
(10) Pub. No.: US 2026/0323808 A1
(43) Pub. Date: Oct. 15, 2026

(54) DEVICES AND METHODS FOR FORMING A HIGH FLUX SPHEROMAK PLASMA AND SYSTEMS CONTAINING THE SAME

(71) Applicants: TAE Technologies, Inc., Foothill Ranch, CA (US); The Trustees of Princeton University, Princeton, NJ (US)

(72) Inventors: Masaaki YAMADA, Princeton, NJ (US); Hiroshi GOTA, Foothill Ranch, CA (US)

(73) Assignee: The Trustees of Princeton University, Princeton, NJ (US)

(21) Appl. No.: 19/485,796

(22) PCT Filed: May 17, 2024
(86) PCT No.: PCT/US2024/030015

§ 371 Date: Nov. 19, 2025

Related U.S. Application Data
(60) Provisional application No. 63/467,882, filed on May 19, 2023.

(51) Int. Cl. H05H 1/54; G21B 1/05; H05H 1/04; H05H 1/48

(52) U.S. Cl. CPC H05H 1/54; G21B 1/052; H05H 1/04; H05H 1/48

(57) ABSTRACT

Devices and methods for forming a spheromak plasma with targeted properties are described. The targeted properties can include a kinetic energy, an ejection speed, a plasma current, a magnetic flux, and a magnetic helicity. Examples of a high flux spheromak gun can include numerous components based on location, function, dimension, and/or constituent material. The components can include an inner electrode, an outer electrode, an inner bias coil, an outer bias coil, a ferromagnetic-core, one or more gas-puff valves, a power supply, and an electronic controller programmed to implement a magnetic flux injection scheme. Systems, such as field-reversed configuration (FRC) systems, employing the devices and methods are also described.

### CROSS REFERENCE TO RELATED APPLICATION

This application claims the benefit of U.S. Provisional Application No. 63/467,882, filed on May 19, 2023, the contents of which are incorporated by reference herein.

### STATEMENT REGARDING FEDERALLY SPONSORED RESEARCH

This invention was made with government support under DE-AC02-09CH11466 awarded by the Department of Energy. The government has certain rights in the invention.

### FIELD

The subject matter described herein relates generally to devices and methods for forming a spheromak plasma configuration and systems containing the same.

### BACKGROUND

A spheromak, also referred to as a Taylor state, is a plasma configuration resembling a smoke ring and belongs to a class of magnetic plasma confinement topologies known as compact toroids (CTs). It typically exhibits both toroidal and poloidal magnetic fields which imbues the plasma with net magnetic helicity, see for example, M. Yamada et al., “Quasistatic formation of Spheromak Plasma Configuration”, Phys. Rev. Lett. 46, 188 (1981), and A. Janos, G. W. Hart and M. Yamada, “Relaxation of Spheromak Plasmas Toward a Minimum-Energy State and Global Magnetic Fluctuations”, Phys. Rev. Lett. 55, 2868-2871 (1985). The attractions of such a configuration can include its inherent stability and long-lived confinement times (without external magnetic fields) due to a near ideal force-free balance between internal electric currents and their associated magnetic fields. Spheromaks generally relax quickly to a stable minimum energy (Taylor) state independent of initial conditions and therefore have predictable behavior, which can be valuable on account of the numerous nonlinearities and/or instabilities related with plasma confinement systems. These self-organizing attributes are a result of the nontrivial magnetic topology of spheromaks and conservation of magnetic helicity within the plasma.

Besides the considerable research interest surrounding spheromaks, e.g., astrophysical plasma research, progress has been made in the last decade developing spheromaks for state-of-the-art fusion reactors. In particular, counter-helicity spheromak merging for field-reversed configuration (FRC) formation has become a promising method for plasma initialization and controlled nuclear fusion, see for example, M. Yamada, Y. Ono et al., “Magnetic Reconnection of Plasma Toroids with Co- and Counter-Helicity”, Phys. Rev. Lett. 65, 721 (1990) and H. Gota et al., “Achievement of Field-Reversed Configuration Plasma Sustainment via 10 MW Neutral-Beam Injection on the C-2U Device”, Nucl. Fusion 57, 116021 (2017). FRC plasmas have a number of desirable features for sustained fusion, e.g., simple geometry for ease of construction and maintenance, a natural unrestricted divertor for facilitating energy extraction and ash removal, and very high β (β being the ratio of the average plasma pressure to the average magnetic field pressure inside the FRC), i.e., high power density. The high β nature is advantageous for economic operation and for the use of advanced aneutronic fuels such as deuterium-helium-3 (D-³He) and proton-boron-11 (p-¹¹B). FRCs have proved to be robust, resilient to dynamic formation, translation, and violent capture events. Moreover, they show a tendency to assume a preferred plasma state, see for example, H. Y. Guo, A. L. Hoffman, K. E. Miller, and L. C. Steinhauer “Flux Conversion and Evidence of Relaxation in a High-β Plasma Formed by High-Speed Injection into a Mirror Confinement Structure”, Phys. Rev. Lett. 92, 245001 (2004).

However, existing devices and methods for spheromak formation and injection, e.g., for use in counter-helicity spheromak merging, produce FRCs with insufficient trapped-magnetic-flux and power densities, as well as contaminating the FRCs with significant impurity injection. These shortcomings limit plasma heating effects from neutral-beam injection (NBI) and rotating magnetic field (RMF) current drives, which can help maintain a high-temperature, high-pressure plasma within a fusion reactor and/or a confinement chamber. Accordingly, a need exists for improved devices and methods for forming high flux spheromak plasmas with targeted properties, as well as systems containing the same.

### SUMMARY

The subject matter described herein relates generally to devices and methods for forming a spheromak plasma configuration with certain targeted properties, e.g., a targeted kinetic energy, plasma current, magnetic flux, and magnetic helicity. The subject matter described herein also relates generally to systems employing such devices and methods. Examples of a high flux spheromak gun are described in an example context of a field-reversed configuration (FRC) confinement system implementing counter-helicity spheromak merging using two opposingly-coupled spheromak guns. The example FRC systems containing the spheromak guns can be implemented in various settings, e.g., nuclear fusion, plasma physics research, etc. However, the spheromak guns are not limited to such. The high flux spheromak gun can include numerous components based on location, function, dimension, and/or constituent material.

The spheromak gun can include an outer electrode and an inner electrode that are coaxial with each other along a central axis. The spheromak gun can also include an outer bias coil positioned about the outer electrode and an inner bias coil positioned within the inner electrode such that the bias coils are mutually coaxial with the electrodes along the central axis. A cavity of vacant space between the electrodes can support a plasma. The plasma can be manipulated by magnetic fields generated by the electrodes and the bias coils. In particular, the electrodes can be configured to conduct current parallel to the central axis to generate a toroidal magnetic field in the plasma. The toroidal magnetic field can be associated with a radial current driven through the plasma and a toroidal magnetic flux injected into the plasma during spheromak formation. Moreover, by way of a Lorentz force on the radial current, the toroidal magnetic field can accelerate the plasma parallel to the central axis such that the plasma is ejected from the gun at a desired speed and kinetic energy. The inner electrode can also be extended with a variable sized head to provide an increased distance for plasma acceleration and toroidal flux injection. The bias coils can be configured to conduct current azimuthally about the central axis to generate a poloidal magnetic field in the plasma. The poloidal magnetic field can be associated with a toroidal current induced in the plasma and a poloidal magnetic flux injected into the plasma during spheromak formation. The inner bias coil can also include a ferromagnetic-core, such as an iron-core (e.g., a cast iron-core or a pure iron-core), to increase the poloidal magnetic flux per unit of current through the bias coils. The injection of both toroidal and poloidal magnetic fluxes creates a magnetic flux linkage in the plasma, imbuing the plasma with net magnetic helicity. Moreover, simultaneous poloidal (e.g., radial) and toroidal current drive provides a means of guiding the plasma towards the spheromak configuration while minimizing magnetic helicity and magnetic energy loss. The spheromak gun can also include a high-voltage (HV) power supply electrically connected to the electrodes and the bias coils. The power supply can provide voltages and currents to the electrodes and the bias coils in order to generate their respective magnetic fields. An electronic controller can be in communication with (or be a component of) the power supply to implement a desired magnetic flux injection scheme. Specifically, the controller can be programmed to generate control signals that cause the power supply to vary the magnetic fields generated by the electrodes and the bias coils in order to form the high flux spheromak plasma. One or more gas-puff valves can be disposed on a periphery of the gun. The one or more gas-puff valves can be configured to inject a gas into the cavity between the electrodes. The power supply can apply a high-voltage discharge across the electrodes to breakdown (e.g., ionize) the gas into the plasma, which can thereafter be manipulated by the magnetic fields generated by the electrodes and the bias coils (e.g., according to the magnetic flux injection scheme) to form the desired spheromak configuration. Numerous implementations of high flux spheromak guns are disclosed that perform some or all of these abovementioned functions. Numerous exemplary materials are disclosed with capabilities to perform one or more of these functions.

Other systems, devices, methods, features and advantages of the subject matter described herein will be or will become apparent to one with skill in the art upon examination of the following figures and detailed description. It is intended that all such additional systems, methods, features and advantages be included within this description, be within the scope of the subject matter described herein and be protected by the accompanying claims. In no way should the features of the example embodiments be construed as limiting the appended claims, absent express recitation of those features in the claims.

### BRIEF DESCRIPTION OF DRAWINGS

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1A shows an example of a spheromak plasma configuration.

FIG. 1B shows an example of a magnetic flux linkage having net magnetic helicity.

FIG. 2 is a schematic depicting an example of a spheromak gun.

FIG. 3 is an isometric view depicting an example of a high flux spheromak gun.

FIGS. 4A and 4B are cross-sectional views depicting an example of a high flux spheromak gun.

FIGS. 5A and 5B are cross-sectional views depicting an example of a high flux spheromak gun during active operation.

FIGS. 6A and 6B depict examples of magnetic flux injection schemes that can be performed by a high flux spheromak gun.

FIG. 7 is a flow diagram of an example process for forming a plasma having a spheromak configuration.

FIGS. 8A-8C show stages of an example spheromak formation process during operation of a high flux spheromak gun.

FIG. 9A is a schematic depicting an example of a field-reversed configuration (FRC) confinement system with two opposingly-coupled spheromak guns.

FIG. 9B is a schematic depicting an example of a FRC magnetic system showing magnetic flux and density contours of a FRC plasma confined in a FRC confinement system.

FIG. 10 is a flow diagram of an example process for generating a plasma having a FRC configuration.

### DETAILED DESCRIPTION

This disclosure is not limited to the particular embodiments described and as such may, of course, vary. The terminology used herein is for the purpose of describing particular embodiments only and is not intended to be limiting since the scope of the present disclosure will be limited only by the appended claims.

Example devices and methods are described herein for high flux spheromak formation, which can be implemented in a field-reversed configuration (FRC) confinement system (e.g., including a plasma confinement chamber and various other components). In certain aspects, the present disclosure is directed at the generation and maintenance of a high flux target FRC plasma and axial refueling of the FRC plasma using opposingly-coupled high flux spheromak guns. Accordingly, for ease of description, the example spheromak guns described herein are in the context of generating a high flux spheromak plasma for use in spheromak merging FRC systems, although the examples are not limited to such. The examples can be applied to other plasma physics applications, even those outside of nuclear fusion applications utilizing different energy ranges and magnetic fluxes.

The example high flux spheromak guns described herein are not intended to be viewed in isolation from each other. Various features, elements, components, and functions described with respect to any spheromak gun example provided herein are intended to be freely combinable and substitutable with those from any other spheromak gun example. If a certain feature, element, component, and function is described with respect to only one spheromak gun example, then that that feature, element, component, and function can be used with other spheromak gun examples described herein unless explicitly stated otherwise. This paragraph therefore serves as antecedent basis and written support for the introduction of claims, at any time, that combine features, elements, components, and functions from different spheromak gun examples, or that substitute features, elements, components, and in functions from one spheromak gun example with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

### Spheromaks

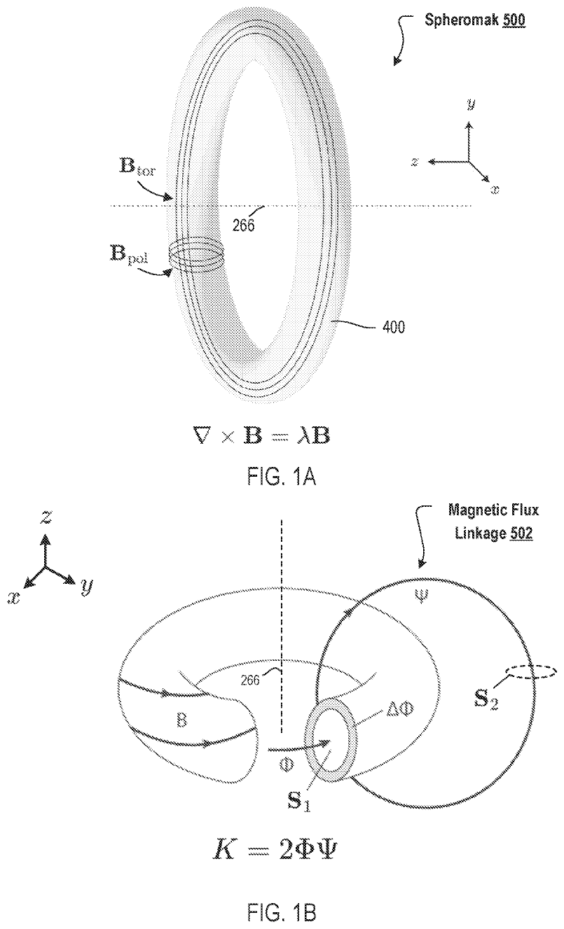

FIG. 1A shows an example of a plasma 400 having a spheromak 500 configuration. The major axis of the spheromak 500 is aligned with a central axis 266. The spheromak 500 is an example of a compact toroid (CT) plasma configuration that can be formed from the spheromak guns delineated in this specification. That being said, the study of spheromaks can be challenging both conceptually and in practice as they generally involve complex magnetic field configurations and unconventional properties such as magnetic helicity. For clarity, a brief review of spheromaks in the context of resistive Hall magnetohydrodynamics (MHD) is provided to appreciate the devices and methods disclosed herein for forming such plasma configurations and systems (e.g., FRC systems) containing the same.

MHD models the plasma 400 as a continuous charged fluid governed by the quasi-static Maxwell's equations and the Navier-Stokes equations. The plasma 400, e.g., an ionized gas, is composed of a fluid of ions and electrons that can conduct electric current. In the quasi-static limit, the magnetic field B of the plasma 400 is related to the current density J of the plasma 400 by Ampère's circuital law:

$$∇ \times B = {μ}_{0} J$$

μ₀ being the permeability of free space. Ampère's circuital law ignores the displacement current generated from the electric field E but this contribution is generally negligible in MHD systems due to relatively slow oscillating currents in the plasma 400. That is, the wavelengths of radiative effects are generally significantly larger than the length scales in MHD systems and therefore can be ignored to good approximation. The magnetic field is divergenceless, Λ·B=0, and related to the electric field by Faraday's law:

$$∇ \times E = - \frac{\partial B}{\partial t}$$

Ohm's law relates the electromagnetic forces to the current density J and the velocity field v of the plasma 400:

$$E + v \times B = kJ$$

k=1/σ is the resistivity which is the inverse of the conductivity σ. When k≠0, the resistivity accounts for Ohmic dissipative effects which, as described below, influence the lifetimes of the spheromak 500. The continuity equation describes conservation of mass in the plasma 400:

$$\frac{\partial ρ}{\partial t} + ∇ \cdot ( ρ v ) = 0$$

ρ is the mass density of the plasma 400. Combining Navier-Stokes and Maxwell's equations provides the force balance equation:

$$ρ \frac{Dv}{Dt} = J \times B - ∇ p$$

$$\frac{D}{D t} = \frac{\partial }{\partial t} + v \cdot ∇$$

is the material derivative that accounts for the convective rate of change of the plasma 400. The left-hand side of the above equation corresponds to the change in momentum (i.e., acceleration) of the plasma 400, while the right-hand side corresponds to the sum total forces acting on the plasma 400. J×B is the Lorentz force and Λp is the pressure force due to the plasma pressure p. Other hydrodynamic effects can also be included in the above equation (e.g., viscoelastic effects) to refine the MHD model. Moreover, the above equation can also include electric forces due to E acting on the charge density but these contributions are generally negligible compared to the Lorentz force J×B.

A useful quantity, the Beta of the plasma β=p/p_{B}, is the ratio between the (average) plasma pressure p and the (average) magnetic field pressure p_{B}=B²/(2μ₀), where B²=B·B is the squared magnitude of the magnetic field. In general, plasmas with β<<1 are influenced predominately by electromagnetic forces while plasmas with β>>1 are influenced predominately by hydrodynamic fluid forces. If the plasma 400 has β<<1 and/or relatively constant pressure, the pressure gradient term is negligible Λp≈0. In most cases, spheromaks 500 correspond to β<<1 and store their internal energy, which can be considerable, in their internal magnetic fields.

Note, due to the axisymmetric geometries of the spheromak guns disclosed herein, cylindrical coordinates are implemented throughout. In a cylindrical basis, vector quantities such as the magnetic field and the current density can be expressed in terms of toroidal and poloidal field components. As seen in FIG. 1A for example, the magnetic field of the spheromak 500 can be expressed as B=Bₜₒᵣ+Bₚₒₗ, where Bₜₒᵣ=B_{φ}\hat{φ} is the toroidal magnetic field and Bₚₒₗ=Bᵣ\hat{r}+B_{z}\hat{z} is the poloidal magnetic field. Toroidal fields generally correspond to azimuthal (\hat{φ}) components and poloidal fields generally correspond to radial (\hat{r}) and axial (\hat{z}) components in a cylindrical coordinate system axially aligned with the central axis 266.

The spheromak 500 is the minimum energy state of the plasma 400 while conserving magnetic helicity (also known as a Taylor state). The total magnetic energy U within a volume Ω containing the plasma 400 can be expressed as,

$$U = \frac{1}{2 {μ}_{0}} \int {B}^{2} d Ω$$

The total electric energy is generally negligible compared to the total magnetic energy and can be ignored to good approximation. In the resistive MHD picture, the rate of change in the total magnetic energy is due to Ohmic losses in the plasma 400, corresponding to nonzero resistivity k≠0:

$$\frac{d U}{d t} = \frac{k}{{μ}_{0}^{2}} \int {∇}^{2} B \cdot B d Ω$$

The total magnetic helicity K within the same volume Ω is,

$$K = \int A \cdot B d Ω$$

Here, A is the magnetic vector potential with B=∇×A. Note that the helicity K is gauge invariant assuming the normal component of B is zero on the boundary of Ω, which can be achieved with a highly conductive bounding surface (e.g., a flux conserver, coaxial electrodes). Along similar lines to the magnetic energy, the rate of change in the magnetic helicity is:

$$\frac{d K}{d t} = - \frac{2 k}{{μ}_{0}} \int B \cdot ( ∇ \times B ) d Ω$$

Magnetic helicity is a topological property that typically represents a net linkage of magnetic flux, which can be regarded as a measure of the “knottedness” or the “twistedness” of the magnetic field. An example of a magnetic flux linkage 502 having net magnetic helicity is shown in FIG. 1B. The magnetic flux linkage 502 is an example of a magnetic flux linkage that can be generated by the spheromak guns disclosed herein. In this case, Φ=∫Bₜₒᵣ·dS₁ corresponds to the flux of toroidal magnetic field Bₜₒᵣ through the surface S₁ and Ψ′=∫Bₚₒₗ·dS₂ corresponds to the flux of poloidal magnetic field Bₚₒₗ through the surface S₂. Using the above equation for K and application of Fubini's Theorem, it can be shown that the corresponding magnetic helicity is:

$$K = 2 Φ Ψ$$

That is, the magnetic helicity K is twice the product of the toroidal magnetic flux Φ and the poloidal flux Ψ, therefore having units of magnetic flux squared. The total magnetic helicity can be understood as two singly linked magnetic flux tubes, Φ and Ψ, respectively.

When the plasma 400 possesses net magnetic helicity, it tends to self-organize from small-scale structures to large-scale ones, regardless of initial conditions. This property is utilized by the spheromak guns and FRC systems disclosed herein to generate predictable and repeatable plasma configurations, which can be considerably valuable for nuclear fusion applications.

As mentioned above, the spheromak 500 is the minimum energy state of the plasma 400 while conserving magnetic helicity. Taylor relaxation, that is, the magnetic reconnection process from an initial plasma state to the spheromak 500 state, generally occurs rapidly on time scales significantly faster than resistive decay times (e.g., by nonlinear MHD processes). Hence, the resistivity is generally negligible k≈0 during relaxation to the spheromak 500 configuration. Minimizing the total energy U of the plasma 400, while conserving the helicity K, results in the following eigenvalue equation for the spheromak 500 configuration:

$$∇ \times B = λ B$$

Taking the curl of the eigenvalue equation and using the divergenceless of the magnetic field produces the Helmholtz equation Λ²B+λ²B=0. Here, λ is the eigenvalue of the spheromak 500 and has units of inverse length. A can be positive or negative corresponding to positive or negative helicity. In general, 1/|λ| represents the characteristic size of the spheromak 500 and depends on the geometry of the system forming it, e.g., the geometry of a spheromak gun. It can also be shown that the eigenvalue λ is related to the magnetic energy U and the magnetic helicity K through Kλ=2μ₀U, meaning increased magnetic helicity (and magnetic flux) directly corresponds to increased magnetic energy.

Moreover, utilizing Ampère's circuital law gives the relationship to the current density λB=μ₀J. Absent external magnetic fields, the Lorentz force vanishes J×B=0 as the magnetic field B and the current density J are parallel (or antiparallel) at each point in the plasma 400. Hence, the spheromak 500 is in a force-free minimum energy state

$$ρ \frac{Dv}{Dt} = 0 ,$$

assuming β<<1. Since B and J are directly proportional, the magnetic flux through any open surface ψ=∫B·dS is directly proportional to the current I=∫J·dS through the same surface

$$ψ = \frac{{μ}_{0}}{\vert λ \vert} I = {L}_{0} I .$$

Accordingly, the eigenvalue of the spheromak 500 can also be interpreted as a natural inductance L₀=μ₀/|λ|.

The force-free configuration is generally stable because the spheromak 500 cannot lose energy by rearranging its streamlines—the total lifetime of the spheromak 500 is primarily limited by long time scale Ohmic losses. That is, after Taylor relaxation, the spheromak 500 will eventually decay due to Joule (or Ohmic) heating. Using the spheromak 500 eigenvalue equations above, it can be shown that the total magnetic energy satisfies (approximately) a first-order rate equation \dot{U}=−U/τ, where τ=μ₀σ/(2λ²)=R₀/(2L₀) is the time constant corresponding to resistive decay of the spheromak 500 and R₀=σ/|λ| is the natural resistance of the spheromak 500. Here, an overdot denotes the derivative with respect to time t and U/τ is the energy dissipation rate. The magnetic helicity satisfies an analogous rate equation \dot{K}=−K/τ, where K/τ is the helicity dissipation rate. Consequently, increasing and sustaining the magnetic helicity of the spheromak 500 directly corresponds to increasing and sustaining its magnetic energy. Spheromak configurations can have relatively long-lived confinement times. For example, the resistive decay time t of the spheromak 500 can be about 100 μs to 500 μs. The spheromak guns disclosed herein can exploit this property to implement relatively slow spheromak formation processes (e.g., >100 μs), facilitating enhanced magnetic helicity and flux injection.

### Examples of Spheromak Guns

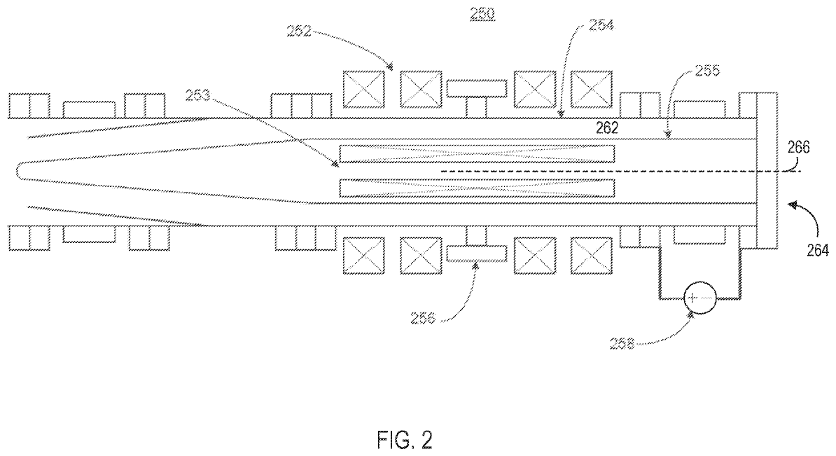

FIG. 2 shows an example of a spheromak gun 250 that can form spheromak plasma configurations, e.g., the spheromak 500 configuration of FIG. 1A. The spheromak gun 250 is relatively compact—about a tenth the size of the high flux spheromak guns described hereinafter. Spheromak gun 250 is an example of a magnetized coaxial plasma gun (MCPG) than can be utilized in small scale field-reversed configuration (FRC) confinement systems, e.g., to initialize target FRC plasmas with trapped-magnetic-fluxes of ~5 mWb or more. That being said, the spheromak gun 250 can also implement the control sequences (e.g., magnetic flux injection schemes) described later with respect to the high flux spheromak guns in order to enhance FRC plasma initialization in such small scale systems.

The spheromak gun 250 includes multiple axisymmetric elements: two coaxial electrodes that include an outer electrode 254 and a tungsten coated inner electrode 255, an outer bias coil 252 positioned about the outer electrode 254 and an inner bias coil 253 positioned within the inner electrode 255. The electrodes 254/255 and the bias coils 252/253 are mutually coaxial with one another, i.e., they share a central axis 266. A gas-puff valve 256 is disposed on a periphery of the gun 250 near a midpoint of the bias coils 252/253. A high-voltage (HV) power supply 258 is electrically connected to the electrodes 254/255 and the bias coils 254/255 to power the elements 252, 253, 254 and 255 of gun 251, e.g., by providing appropriate voltages and currents. A plasma can be generated in a cavity 262 between the outer electrode 254 and the inner electrode 255 by ionization of a gas injected by the gas-puff valve 256. The plasma can be manipulated by magnetic fields generated by electrodes 254/255 and bias coils 252/253 and subsequently ejected from an ejection port 264, e.g., an opening of the cavity 262 at an end of the gun 250. Although not depicted in FIG. 2, an electronic controller can be in communication with (or be a component of) the power supply 258 to execute a magnetic flux injection scheme that facilitates spheromak formation. That is, the electronic controller can be programmed to generate control signals that cause the power supply 258 to vary the voltages and currents provided to the electrodes 254/255 and the bias coils 252/253, thereby varying the corresponding magnetic fields generated by the electrodes 254/255 and the bias coils 252/253. As is described in more detail below, the electronic controller is generally programmed to drive poloidal and toroidal currents in the plasma while injecting magnetic flux and magnetic helicity. Driving poloidal and toroidal currents simultaneously allows the spheromak gun 250 to effectively guide the plasma towards the Taylor minimum energy state and maximize helicity injection.

The spheromak gun 250 produces a sufficiently high magnetic flux spheromak by utilizing and upgrading a recently developed iron-core bias coil system, see for example, T. Edo et al., “Performance Improvement of a Magnetized Coaxial Plasma Gun by Adopting Iron-Core Bias Coil and Pre-Ionization Systems”, Plasma and Fusion Res. 13, 3405062 (2018). In preliminary tests, an air-core bias coil with a direct current (DC) power supply produces a poloidal magnetic flux of the formed spheromak scaled with ~1.67 μWb/A, while the MCPG with iron-core (e.g., cast iron with a relative magnetic permeability μᵣ~250) bias coil system can produce roughly 100 times higher magnetic flux per Amp (e.g., ~0.16 mWb/A). By fixing the peak amplitude of the current density, the spheromak gun 250 can be adequately scaled up in size to produce a significantly higher magnetic flux per Amp, without causing undesirable effects typically associated with electrode discharges, e.g., electrode impurity injection. An example of such a high flux spheromak gun with additional design and control system modifications (e.g., bias coils with an alternating current (AC) power supply) is described below. In a further example, the iron-core is formed using pure iron (e.g., 99.9% Fe with a relative magnetic permeability μᵣ>200,000). Due to the increased inductance, a pure iron-core can achieve even higher magnetic flux with the same bias current.

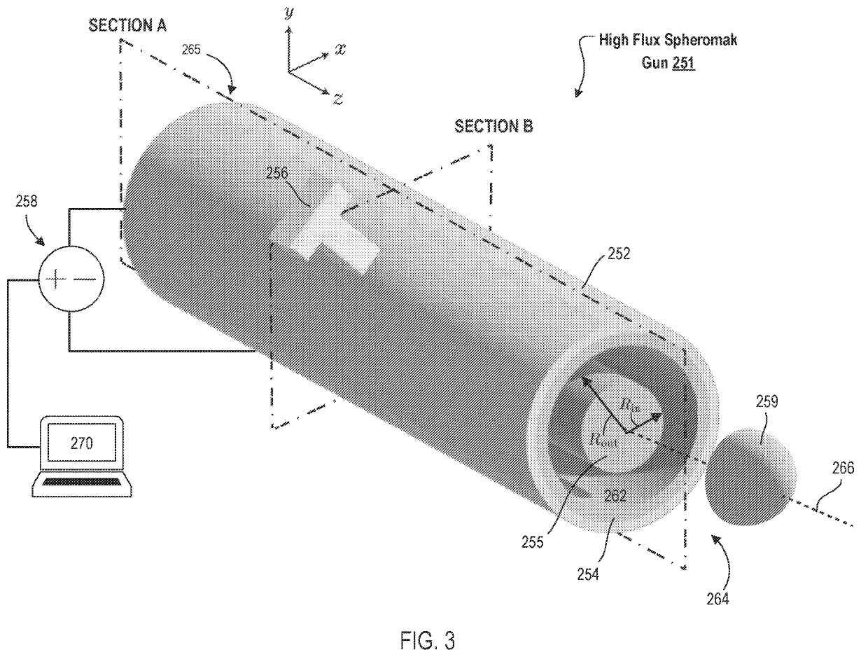

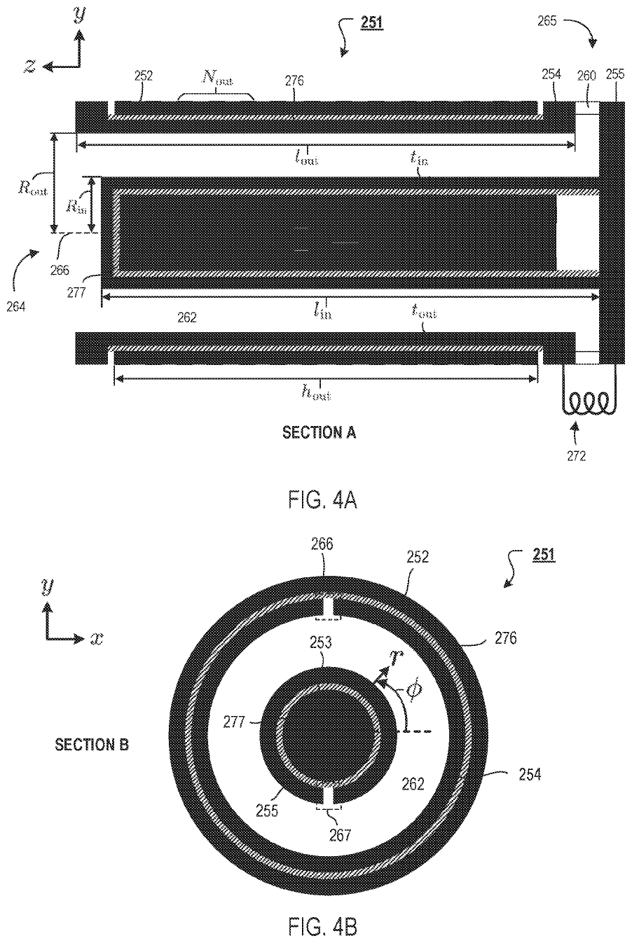

FIG. 3 shows an isometric view of an example high flux spheromak gun 251 that can form high flux spheromak plasma configurations, e.g., the spheromak 500 configuration of FIG. 1A. The high flux spheromak gun 251 is relatively large—about ten times the size of the spheromak gun 250 in FIG. 2. By means of inductive flux injection, the high flux gun 251 can form spheromak plasma configurations with superior properties (e.g., poloidal magnetic flux of ~30 mWb or more and ejection speeds of ~100 km/s or more), while mitigating undesirable effects such as electrode impurity injection. When utilized for counter-helicity spheromak merging in field-reversed configuration (FRC) systems, the gun 251 enables the formation of target FRC plasmas with high trapped-magnetic-flux (e.g., ~30 mWb or more) and increased power densities. High-magnetic-flux FRCs allow more effective capture of fast neutral-beam injection (NBI) particles, thus enhancing the effects of NB heating as well as rotating magnetic field (RMF) current drives. FIG. 3 provides an overview of the high flux spheromak gun 251. The detailed structure and electromagnetic properties of the gun 251 will be elaborated when referring to FIGS. 4A and 4B.

Spheromak gun 251 includes an outer electrode 254 and an inner electrode 255 that are coaxial with each other along a central axis 266. A cavity 262 of vacant space is formed between the electrodes 254/255 to support a plasma. The electrodes 254/255 resemble a coaxial cable and are configured to conduct current parallel to the central axis 266 (in the 2 direction). The axial currents in the electrodes 254/255 generate toroidal magnetic fields and fluxes in the plasma. The inner electrode 255 can also be affixed with a variable length head 259 to extend inner electrode 255, e.g., to extend the distance for acceleration of the plasma. In this case, the head 259 has a hemispherical shape but other axisymmetric shapes, e.g., cones, paraboloids, cylinders, etc. are also possible.

An outer bias coil 252 is positioned about the outer electrode 254. Although not shown in FIG. 3, an inner bias coil 253 is positioned within the inner electrode 255, see for example, FIGS. 4A and 4B. The bias coils 252/253 resemble a coaxial transformer and are configured to conduct current azimuthally about the central axis 266 (in the \hat{φ} direction). The azimuthal currents in the bias coils 252/253 generate poloidal magnetic fields and fluxes in the plasma. Hence, from a high level perspective, the high flux spheromak gun 251 can be interpreted as a coaxial cable situated between a coaxial transformer. This arrangement allows the spheromak gun 251 to generate magnetic flux linkages in the plasma (e.g., the magnetic flux linkage shown in FIG. 1B), instilling the system with net magnetic helicity.

Note that the electrodes 254/255 and the bias coils 252/253 are depicted as cylindrical elements in FIG. 3 as an example structure. More generally, electrodes 254/255 and bias coils 252/253 can be axisymmetric elements, i.e., having rotational symmetry about the central axis 266. For example, the electrodes 254/255 and bias coils 252/253 can have conical, parabolic, hemispherical, tapered shapes and/or portions, among other axisymmetric geometries. Although different structures are feasible, axisymmetric geometries are usually optimal for spheromak formation due to the spheromak's toroidal shape, as seen in the example spheromak 500 of FIG. 1A. For instance, the cavity 262 between the electrodes 254/255 has an annular shape to support the CT plasma configuration, such that the central axis 266 corresponds to the major axis of the spheromak 500. The annular cavity 262 has an inner radius of Rᵢₙ and an outer radius of Rₒᵤₜ coinciding with the dimensions of the electrodes 254/255. The eigenvalue λ of the resulting spheromak is approximately |λ|≈π/Δd, where Δd=Rₒᵤₜ−Rᵢₙ is the spacing between the electrodes 254/255. Accordingly, the geometry of the spheromak gun 251 can be tuned to form spheromaks of a desired characteristic size.

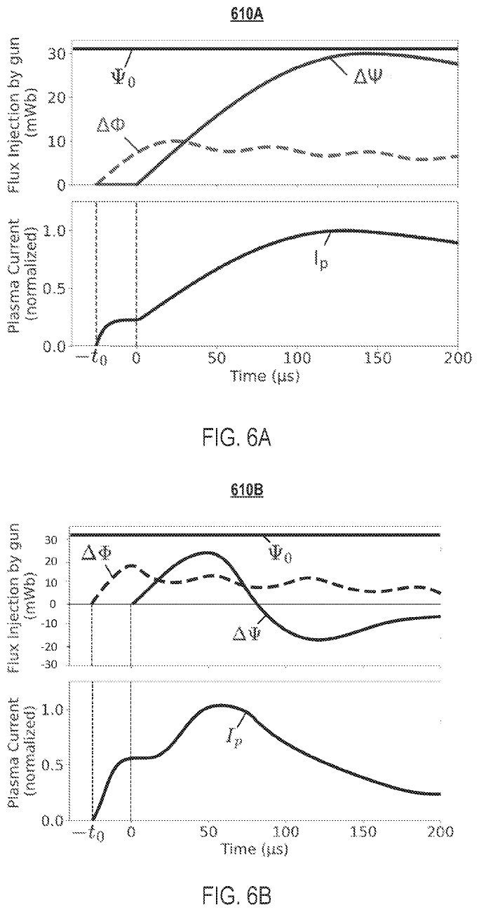

To generate the magnetic fields and fluxes, the gun 251 includes a high-voltage (HV) power supply 258 that is electrically connected to the electrodes 254/255 and the bias coils 252/253. The power supply 258 is configured to supply adequate power (e.g., time-varying (AC) and/or steady-state (DC) voltages and currents) to the electrodes 254/255 and the bias coils 252/253. An electronic controller 270 is in communication with the power supply 258 to implement a desired control sequence, e.g., a magnetic flux injection scheme. Details of example magnetic flux injection schemes are described with respect to FIGS. 6A and 6B. Specifically, the controller 270 is programmed to generate control signals that cause the power supply 258 to vary the voltages and currents supplied to the electrodes 254/255 and the bias coils 252/253. In this way, the corresponding magnetic fields and fluxes are also varied to manipulate the plasma supported in the cavity 262. Note that the controller 270 is depicted as a separate entity from the power supply 258 for convenience. However, in general, the functions of the controller 270 can also be accomplished by an appropriately programmed power supply 258. Alternatively or in addition, the controller 270 can be a component of the power supply 258 itself.

A gas-puff valve 256 is located on a periphery of the gun 251 near a midpoint of the bias coils 252/253, similar to the spheromak gun 250 of FIG. 2. The gas-puff valve 256 is configured to inject a gas into the cavity 262, e.g., a neutral gas, a pre-ionized gas, a hydrogen gas, a deuterium gas, a helium-3 gas, a tritium gas, etc. For example, the gas-puff valve 256 can be connected to a suitable pump system to inject the gas at a desired pressure. In some implementations, the gas corresponds to one or more components of a nuclear fusion fuel in which case the spheromak gun 251 can be utilized for fusion ignition and/or maintenance, e.g., plasma initialization and axial refueling in FRC systems. The spheromak gun 251 can accommodate advanced aneutronic fuels such as proton-boron (p-¹¹B) and deuterium-helium-3 (D-³He), as well as conventional deuterium-tritium (D-T) fuels. From a testing and experimental perspective, the spheromak gun 251 can also support high Z stable gases (e.g., neon, argon, krypton, etc.) to study the behavior of different types of plasmas in various settings. However, such gases are generally not used for fusion reactor applications. Spheromak gun 251 can include multiple gas-puff values (e.g., 2, 3, 4 or more gas-puff valves) to evenly disperse the gas within the cavity 262. For example, multiple gas-puff valves 256 can be orientated tangentially on a circumference of the gun 251 to evenly disperse the gas azimuthally within the cavity 262. To inject the gas at relatively fast rates, the gas-puff valves 256 can be fast solenoid valves, e.g., Parker Hannifin Corp., model: 009-0442-900. Note that the electronic controller 270 can also be in communication with the gas-puff valves 256 (e.g., through a pump system) in order to sequence gas injection with voltage discharges provided from the power supply 258.

The power supply 258 can apply a high-voltage discharge V_{dis} across the electrodes 254/255 to breakdown the gas into the plasma, e.g., ionizing the gas. According to Paschen's law, the characteristics of plasma breakdown are generally influenced by three factors for a given gas: (1) the discharge voltage V_{dis}, (2) the spacing Δd=Rₒᵤₜ−Rᵢₙ between the electrodes 254/255, and (3) the pressure p of the gas, all of which can be balanced to optimize an ionization rate of the gas. For example, the discharge voltage V_{dis} is typically on the order of about 103 V to 105 V to exceed the breakdown voltage V_{B} of the gas. The breakdown voltage is (approximately) proportional to the product of the gas pressure and the electrode spacing V_{B} ∝pΔd. For fixed electrode spacing Δd, higher pressure gases generally involve increased discharge voltages to overcome the increased breakdown voltage. The pressure of the gas relative to vacuum can be about 40 pounds per square inch absolute (psia) or more (e.g., about 45 psia or more, about 50 psia or more, about 55 psia or more, about 60 psia or more) to ensure an adequate density of gas and resulting density of plasma. For example, the mass density of gas ρ may be approximated by the ideal gas law p=ρRₛT, where Rₛ is the specific gas constant and T is the temperature of the gas.

Following breakdown of the gas, the electrodes 254/255 can accelerate the resulting plasma by an axial Lorentz force to eject the plasma out of an ejection port 264. The gun 251 can eject the plasma at ejection speeds of about 100 km/s or more (e.g., about 125 km/s or more, about 150 km/s or more, about 175 km/s or more, about 200 km/s or more). In this case, the port 264 is a cylindrical opening of the cavity 262 at a front end of the gun 251 but tapered and/or collimated ejection ports 264 are also feasible, among other axisymmetric shapes. Upon ejection from the gun 251, the plasma quickly relaxes to a spheromak configuration due to the captured magnetic flux (and helicity) generated by the electrodes 254/255 and the bias coils 252/253. In general, the length of the spheromak formation region, i.e., the region where the plasma captures the magnetic flux and is accelerated by the electrodes 254/255, coincides with the length measured from the gas-puff valve 256 to the ejection port 264.

The gun 251 can support relatively high-temperature plasmas (e.g., about 10 of eV or more, about 20 eV or more, about 30 eV or more, about 40 eV or more, about 50 eV or more, about 60 eV or more) so the materials of various components of the gun 251 are selected judiciously. For example, the electrodes 254/255 can be composed of stainless steel (e.g., SS 304L). Stainless steels are versatile due to their relatively high electrical conductivities, melting points, and heat resistance that are beneficial in high-voltage, high-current and/or high-temperature settings, all of which are typical conditions of spheromak gun 251 during active operation. In general, electrode impurity injection results from extremely high currents through the electrodes 254/255, e.g., about 100 kA to 300 kA or more, as well as thermal contact with the plasma. Both of which can cause degradation of the electrodes 254/255 and contamination of the plasma. Utilizing materials such as stainless steels and limiting peak currents through the electrodes 254/255 to about 300 kA or less can significantly reduce impurity injection. To withstand the high voltages applied to the electrodes 254/255, the bias coils 252/253 can include high-voltage (HV) cables, e.g., Radix Wire Company, HQA22T007.

In some implementations, the outer electrode 254 and/or the inner electrode 255 are coated with tungsten to reduce electrode impurity injection further. The tungsten coating can be about 0.1 μm to 0.5 μm thick to accommodate an additional thermal barrier. Tungsten has the highest melting point of all metals (in pure form) and therefore can be advantageous for improved heat resistance while still providing sufficient electrical conductivity. The tungsten coating can be applied with various techniques, for example, a “Vacuum Plasma Spraying” technique. The head 259 of inner electrode 255 can be stainless steel coated with tungsten, e.g., applied with the Vacuum Plasma Spraying technique. Alternatively, the head 259 can be composed entirely of tungsten.

FIGS. 4A and 4B show cross-sectional views, Section A and Section B respectively, of the high flux spheromak gun 251. For ease of description, reference will be made to both FIGS. 4A and 4B when discussing the detailed structure and electromagnetic properties of spheromak gun 251. Note, when describing the spheromak gun 251 below, various dimensions and device parameters are provided as non-limiting examples of a high flux spheromak gun that can produce target FRC plasmas (e.g., via counter-helicity spheromak merging) with trapped-magnetic-fluxes of about 30 mWb or more. These dimensions are about ten times larger than the spheromak gun 250 of FIG. 2. For reference, as demonstrated experimentally, a mid-sized spheromak gun having intermediate electrode dimensions of Rᵢₙ=6.77 cm and Rₒᵤₜ=12.725 cm is capable of generating a 10 mWb spheromak when a 200 kA peak current is driven through the electrodes 254/255 which can produce target FRC plasmas of about 10 mWb trapped-flux. Nevertheless, utilizing the engineering principles disclosed herein, the spheromak gun 251 can be scaled up for even larger FRC systems with even higher trapped-magnetic fluxes, e.g., about 35 mWb or more, about 40 mWb or more, about 45 mWb or more, about 50 mWb or more, about 55 mWb or more, about 60 mWb or more.

Outer electrode 254 has an inner radius of Rₒᵤₜ, a length of lₒᵤₜ and a thickness of tₒᵤₜ, while inner electrode 255 has an outer radius of Rᵢₙ, a length of lᵢₙ and a thickness of tᵢₙ. To enable FRC systems with ~30 mWb trapped-magnetic fluxes, outer electrode 254 can have an inner radius of Rₒᵤₜ~25 cm and a length of lₒᵤₜ~150 cm, while inner electrode 255 can have an outer radius of Rᵢₙ~15 cm and a length of lᵢₙ~150 cm. In some implementations, the inner radius of outer electrode 254 can be about 15 cm to 30 cm and the outer radius of inner electrode 255 can be about 10 cm to 20 cm. In some implementations, the lengths of each of the electrodes 254/255 can be about 100 cm to 200 cm. The thickness of each electrode, tₒᵤₜ and tᵢₙ, can be relatively thin, e.g., about 1 mm to 10 mm, to provide a nearly uniform current sheet and reduced (in some cases negligible) resistance through the electrodes 254/255.

Analogous to a coaxial cable, the electrodes 254/255 have a shunt capacitance per unit length of approximately [symbol] ≈2πϵ₀/ln (Rₒᵤₜ/Rᵢₙ) and a series inductance per unit length of approximately [symbol] ≈μ₀ ln (Rₒᵤₜ/Rᵢₙ)/2π, which depend on the ratio of the electrode radii Rₒᵤₜ/Rᵢₙ. For the aforementioned dimensions, the capacitance and inductance per unit length are approximately [symbol] ~100 pF/m and [symbol] ~100 nH/m, respectively. Holding the ratio Rₒᵤₜ/Rᵢₙ constant allows the spheromak gun 251 to be scaled up without significantly changing these electromagnetic properties.

The electrodes 254/255 can also include linear slits 266/267 along their lengths to suppress induced toroidal currents in the electrodes 254/255. Accordingly, current is predominantly conducted axially (in the 2 direction) through the electrodes 254/255. Since the bias coils 252/253 are configured to vary the poloidal magnetic field on relatively fast time scales, considering the associated poloidal flux, the linear slits 266/267 can ensure toroidal currents are primarily induced in the plasma. This reduced inductance in the electrodes 254/255 can allow faster operation of the bias coils 252/253. Note that the linear slits 266/267 can also be filled with an insulator (e.g., a ceramic) to provide further isolation between the cavity 262 and the bias coils 252/253.

An insulator 260 at a back end 265 of the gun 251 electrically isolates the electrodes 254/255 from each other while enclosing the cavity 262 at the back end 265. Due to the relatively high operating temperatures of the gun 251 (e.g., tens of eV or more), the insulator 260 can be composed of ceramic or other high-temperature electrical insulator (e.g., high-performance polymers or thermoplastics). Unless a vacuum boundary can be implemented, insulators composed of ceramic are usually utilized by spheromak gun 251 due to their superior properties and durability. The ceramics can include, but are not limited to, porcelain, glass, toughened-glass, clays, carbides, silicons, among others.

A shunt inductor 272 can also be installed between the electrodes 254/255, e.g., with a terminal electrically connected to each of the electrodes 254/255. The shunt inductor 272 can be installed in parallel with the connections of the electrodes 254/255 to the power supply 258. In some implementations, the shunt inductor 272 can be a component of the power supply 258. The shunt inductor 272 can damp released energy if breakdown of a gas does not occur when a high-voltage discharge V_{dis} is applied by the power supply 258 to the electrodes 254/255. For example, the shunt inductor 272 can reroute the current associated with the voltage discharge V_{dis} if the injected gas is not successfully ionized. Shunt inductor 272 can have an inductance of Lₛₕ~20 μH to ensure the current flowing into the shunt inductor 272 is negligible compared to the main electrode currents following successful ionization. In some implementations, the inductance of shunt inductor 272 can be about 10 μH to 50 μH.

Outer bias coil 252 has Nₒᵤₜ turns and a length of hₒᵤₜ, while inner bias coil 253 has Nᵢₙ turns and a length of hᵢₙ. Outer bias coil 252 conducts current azimuthally (in the \hat{φ} direction) around the electrodes 254/255 and inner bias coil 253 conducts current azimuthally within the inner electrode 255. The number of turns in each bias coil 252/253 can be Nₒᵤₜ≈Nᵢₙ~20 and the length of each bias coil 252/253 can be comparable to the electrodes hₒᵤₜ≈hᵢₙ~150 cm. However, similar to the spheromak gun 250 of FIG. 2, the bias coils 252/253 can also be significantly shorter than the electrodes 254/255, e.g., hₒᵤₜ≈hᵢₙ~50 cm, depending on the implementation. In some cases, relatively short bias coils 252/253 can be advantageous as the plasma can be continually accelerated by the electrodes 254/255 after poloidal magnetic flux is injected into the plasma by the bias coils 252/253. Since the electrodes 254/255 are relatively thin, the radius of outer bias coil 252 is roughly equal to Rₒᵤₜ and the radius of inner bias coil 253 is roughly equal to Rᵢₙ. Although other configurations are feasible, thin electrodes 254/255 can ensure poloidal magnetic fields generated by the bias coils 252/253 primarily interact with the plasma and do not induce significant current in the electrodes 254/255. In some implementations, each bias coil 252/253 can have about 10 turns to 30 turns and the length of each bias coil 252/253 can be about 30 cm to 200 cm.

An outer insulator 276 separates and thermally isolates outer bias coil 252 from outer electrode 254. Similarly, an inner insulator 257 separates and thermally isolates inner bias coil 253 from inner electrode 255. Due to the extreme temperatures in the cavity 262, the insulators 276/277 provide thermal protection for the bias coils 252/253 since direct thermal contact with electrodes 254/255 can be damaging. In some implementations, the insulators 276/277 are vacuum boundaries which can nearly eliminate convective and conductive heat transfer between the electrodes 254/255 and the bias coils 252/253. The insulators 276/277 can also include one or more layers of Kapton (e.g., ≈1 mm thick). For example, Kapton tape can be wrapped around the outer surface of inner bias coil 253 and/or the outer surface of outer electrode 254, as well as applied to the inner surface of outer bias coil 252 and/or the inner surface of inner electrode 255. Alternatively or in addition, the insulators 276/277 can include ceramic which can be suitable for high temperature applications. The thicknesses of the insulators 276/277 can be about 1 mm to 10 mm to provide sufficient thermal insulation from the electrodes 254/255.

Inner bias coil 253 can also include a ferromagnetic-core 261 having a relative magnetic permeability greater than one μᵣ>1. The ferromagnetic-core 261 can significantly increase the poloidal magnetic fluxes generated by the bias coils 252/253 with a same biasing current due to increasing inductances of the bias coils 252/253. The ferromagnetic-core 261 can be an iron-core, for example, as cast iron (e.g., μᵣ~250) or pure iron (e.g., 99.9% Fe and μᵣ>200,000) which can increase the poloidal magnetic flux by orders of magnitude. However, the increased inductance from the ferromagnetic-core 261 generally increases the rise times of the bias coils 252/253. If fast variations are desired for bias coils 252/253, the ferromagnetic-core 261 can be neglected and higher amplitude biasing currents can be applied by the power supply 258.

Similar to a coaxial transformer, the self-inductance of the outer bias coil 252 is approximately

$${L}_{o u t} ≃ π {μ}_{0} [ ( {μ}_{r} - 1 ) {R}_{i n}^{2} + {R}_{o u t}^{2} ] {N}_{o u t}^{2} / {h}_{out}$$

and the self-inductance of the inner bias coil 253 is approximately

$${L}_{i n} \approx π {μ}_{0} {μ}_{r} {R}_{i n}^{2} {N}_{i n}^{2} / {h}_{i n} .$$

The mutual inductance between the bias coils 252/253 depends on their relative arrangement in the gun 251 but can be approximated as

$$M \approx {πμ}_{0} {μ}_{r} {R}_{in}^{2} {N}_{o u t} {N}_{i n} / {h}_{o u t}$$

assuming similar lengths hₒᵤₜ≈hᵢₙ. With an air-core (μᵣ=1) and the abovementioned dimensions, the inductances are approximately Lₒᵤₜ≈Lᵢₙ≈M~100 μH. In some implementations, the inductances of the bias coils 252/253 with air-core can be about 10 μH to 1 mH.

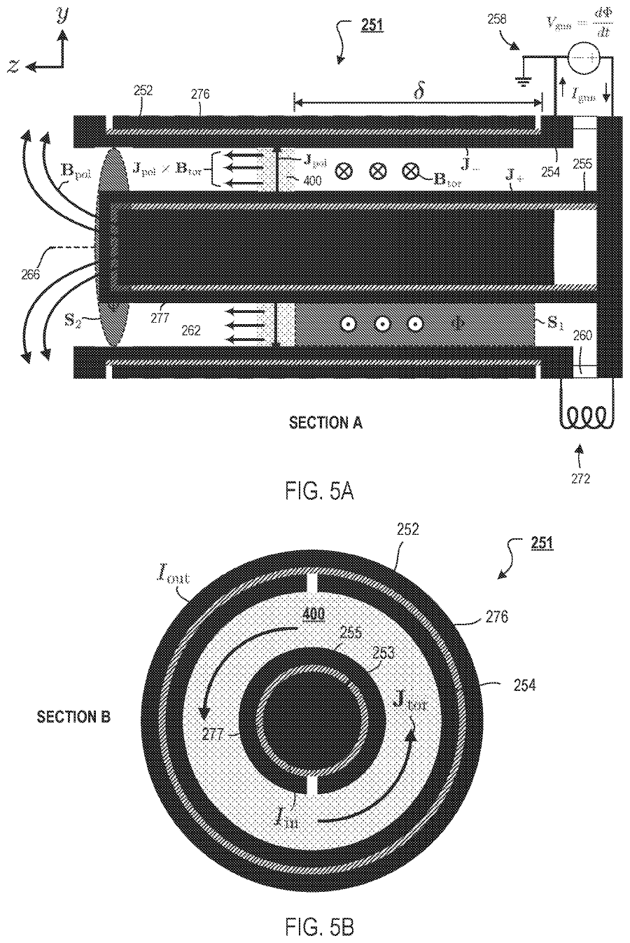

FIGS. 5A and 5B show cross-sectional views, Section A and Section B respectively, of the high flux spheromak gun 251 during active operation. In this case, FIGS. 5A and 5B illustrate operation of the gun 251 after a plasma 400 has been generated between the electrodes 254/255, e.g., after the power supply 258 ionizes a gas injected by the one or more gas-puff valves 256 using a high-voltage discharge V_{dis} across the electrodes 254/255. For ease of description, reference will be made to both FIGS. 5A and 5B when discussing operation of spheromak gun 251.

During active gun 251 operation, outer electrode 254 can be implemented as a cathode or an anode, with inner electrode 255 having the opposite polarity. Either electrode 254 or 255 can be grounded if desired. As an example, FIG. 5A depicts the inner electrode 255 as the cathode and the outer electrode 254 as the anode which is grounded. After plasma breakdown occurs in the cavity 262, an electric arc (e.g., a short circuit) is formed between the electrodes 254/255 by the conduction of poloidal current Jₚₒₗ=Jᵣ\hat{r} radially through the plasma 400. Specifically, the power supply 258 applies a gun voltage V_{gun} across the electrodes 254/255 which drives a total gun current I_{gun} radially through the plasma 400. Electrodes 254/255 conduct the current J_{±}=±J_{±}\hat{z} axially in opposite directions which generates a toroidal magnetic field Bₜₒᵣ=B_{φ}\hat{φ} in the cavity 262, encircling inner electrode 255. The toroidal magnetic field B_{φ} accelerates the plasma 400 by an axial Lorentz Force Jₚₒₗ×Bₜₒᵣ=JᵣB_{φ}\hat{z} generated on the radial current Jᵣ.

Assuming relatively uniform current sheets in the electrodes 254/255, the toroidal magnetic field B_{φ} in the cavity 262 between Rᵢₙ<r<Rₒᵤₜ can be approximated as

$${B}_{ϕ} = \frac{{μ}_{0} {I}_{gun}}{2 π r} .$$

The integral of the toroidal magnetic field Bₜₒᵣ over the surface area dS₁=drdz\hat{φ} gives the toroidal magnetic flux Φ=∫Bₜₒᵣ·dS₁ in the cavity 262. Note that, since the gun current I_{gun} is conducted through the plasma 400, and the plasma 400 is translating along the axis 266, the surface area S₁ generally changes with time. Treating the plasma 400 as a thin radially conducting current sheet, the toroidal flux at any particular time during spheromak formation can be approximated as,

$$Φ \approx \frac{{μ}_{0} {I}_{g u n}}{2 π} ln ( \frac{{R}_{o u t}}{{R}_{i n}} ) δ = ℒ δ {I}_{g u n} = {LI}_{gun}$$

Here, δ is the average displacement of the plasma 400 from the back end 265 of the gun 251 and [symbol] is the inductance per unit length of the electrodes 254/255 described above. L= [symbol] δ is the effective inductance of the electrodes 254/255 after plasma breakdown, which is time-varying \dot{L}= [symbol] v as the plasma 400 is translating. v=\dot{δ} is the average velocity of the plasma 400. Since the plasma 400 is an inductive load, the gun voltage V_{gun} appearing between the electrodes 254/255 corresponds to the rate of injected toroidal flux V_{gun}=\dot{Φ}=\dot{L}I_{gun}+Lİ_{gun}. For slow spheromak formation Lİ_{gun}>>\dot{L}I_{gun}, meaning the gun current I_{gun} varies on time scales faster than the plasma 400 is ejected from the gun 251, the gun voltage is approximately V_{gun}≈Lİ_{gun}. Moreover, the axial Lorentz force JᵣB_{φ} can be characterized by the magnetic pressure on the back of the current sheet

$${p}_{B} = \frac{{B}_{ϕ}^{2}}{2 {μ}_{0}} = \frac{{μ}_{0} {I}_{g u n}^{2}}{8 {π}^{2} {r}^{2}} .$$

The integral over the annular face of the cavity 262 produces the approximate net Lorentz force on the plasma 400 due to the toroidal magnetic field

$$F = \frac{{μ}_{0} {I}_{g u n}^{2}}{4 π} ln ( \frac{{R}_{o u t}}{{R}_{i n}} ) = ℒ {I}_{g u n}^{2} / 2 .$$

The total power P into the plasma 400 related to the change in kinetic energy is approximately

$$P \approx Fv + {V}_{g u n} {I}_{g u n} = d ( {LI}_{g u n}^{2} / 2 ) / d t = d ( m {v}^{2} / 2 ) / d t .$$

Integrating both sides gives the approximate ejection speed of the plasma vₑⱼ.≈Iₑⱼ. \sqrt{L/m}, where Iₑⱼ.=I_{gun} (t_{ej.}) is the gun current at the time of ejection t_{ej.} and m is the mass of the ejected plasma 400. For example, the mass may be approximated as

$$m \approx ρ π ( {R}_{o u t}^{2} - {R}_{i n}^{2} ) Δ z$$

where ρ is the mass density of the plasma 400 and Δz is the thickness of the current sheet.

For the aforementioned dimensions, the effective inductance of the electrodes 254/255 can be L~0.2 μF. In some implementations, the inductance can be about 0.1 μF to 0.5 μF depending on the particularly geometry of the electrodes 254/255. The gun current I_{gun} peak value is generally limited by power supply 258 to about 100 kA to 300 kA to safeguard against electrode impurity injection. This corresponds to a peak toroidal flux of φ~20 mWb and an ejection speed of v_{ej.}~100 km/s for a peak gun current of ~100 kA and a plasma mass of ~0.2 milligrams (mg). In some implementations, for the same peak gun current, the peak toroidal flux can be about 10 mWb to 50 mWb and the ejection speed can be about 70 km/s to 160 km/s depending on the particular geometry of the electrodes 254/255.

During active gun 251 operation, outer bias coil 252 and inner bias coil 253 are supplied bias currents Iₒᵤₜ and Iᵢₙ respectively by the power supply 258. Two bias coils 252/253 provides greater flexibility for spheromak formation than a single bias coil. For example, the respective bias current through either bias coil, or both, can be time-varying. In some implementations, one of the bias coils 252/253 is supplied a steady-state (DC) current and the other is supplied a time-varying (AC) current. For clarity, electrical connections between the coils 252/253 and the power supply 258 are not depicted in FIGS. 5A and 5B but appropriate circuitry can be assumed to generate the bias currents. The circulating currents in each of the bias coils 252/253 generates a poloidal magnetic field Bₚₒₗ=Bᵣ\hat{r}+B_{z}\hat{z} within the gun 251 that interlinks the toroidal field Bₜₒᵣ generated by the electrodes 254/255. The poloidal magnetic field in the inner electrode 255 for radius 0<r<Rᵢₙ is about B_{z}=μ₀μᵣ(NₒᵤₜIₒᵤₜ/hₒᵤₜ+NᵢₙIᵢₙ/hᵢₙ). The poloidal magnetic field in the cavity 262 for radius Rᵢₙ<r<Rₒᵤₜ is about B_{z}=μ₀NₒᵤₜIₒᵤₜ/hₒᵤₜ. Hence, the poloidal magnetic flux Ψ=∫Bₚₒₗ·dS₂ through a cross-sectional surface area dS₂=rdrdφ\hat{z} of the gun 251 is approximately,

$$Ψ \approx \frac{{L}_{o u t}}{{N}_{o u t}} {I}_{o u t} + \frac{{L}_{i n}}{{N}_{in}} {I}_{in} = {Ψ}_{o u t} + {Ψ}_{i n}$$

As can be seen in the above equation, the poloidal flux Ψ is directly proportional to the inductances, Lₒᵤₜ and Lᵢₙ, of the bias coils 252/253 and the bias currents, Iₒᵤₜ and Iᵢₙ, passing through the bias coils 252/253. The bias currents Iₒᵤₜ and Iᵢₙ can have peak values of about 10 kA to 15 kA. Assuming an air-core (μ=1) and the gun 251 parameters stated previously, this corresponds to poloidal magnetic fluxes

$${Ψ}_{o u t} = \frac{{L}_{o u t}}{{N}_{o u t}} {I}_{o u t} and {Ψ}_{i n} = \frac{{L}_{i n}}{{N}_{i n}} {I}_{in}$$

having peak values of ~30 mWb for each of the bias coils 252/253. In some implementations, for the same bias currents Iₒᵤₜ and Iᵢₙ, the peak values of the poloidal magnetic fluxes can be about 10 mWb to 50 mWb, depending on the particular geometries of the bias coils 252/253 and/or presence of a ferromagnetic-core 261. Note that the poloidal magnetic fields and fluxes can superpose constructively or destructively depending on the direction of bias current in each coil.

For time-varying bias currents, the corresponding voltage drops across the bias coils 252/253 are Vₒᵤₜ≈Lₒᵤₜ İₒᵤₜ+Mİᵢₙ and Vᵢₙ≈Lᵢₙİᵢₙ+Mİₒᵤₜ for the outer bias coil 252 and the inner bias coil 253 respectively, where M is the mutual inductance. In general, the time-varying magnetic fluxes \dot{Ψ}ₒᵤₜ≠0 and/or \dot{Y}ᵢₙ≠0 induce a toroidal current Jₜₒᵣ=J_{φ}\hat{φ} in the plasma 400 due to an induced electromotive force (emf). Assuming perfect coupling between the bias coils 252/253 and the plasma 400 as a rough approximation, the induced voltage V_{ind} in the plasma 400 corresponds to the rate of injected poloidal flux V_{ind}=\dot{Ψ}. The associated power transfer may be approximated as V_{ind} I_{ind}≈VₒᵤₜIₒᵤₜ+VᵢₙIᵢₙ, where I_{ind} is the total induced toroidal current.

Referring to FIG. 1A, the representation of a spheromak 500 configuration in terms of its eigenvalue equation ∇×B=λB also suggests one or more effective eigenvalues A for the spheromak gun 251 itself:

$$Λ = \frac{\int ( ∇ \times B ) \cdot dS}{\int B \cdot dS} = \frac{{μ}_{0} \int J \cdot dS}{\int B \cdot dS}$$

1/Λ provides a measure of the characteristic “size” of the gun 251 in terms of its electromagnetic properties, which can be expressed as the ratio of the current density and magnetic field threading the same surface. Since the high flux gun 251 drives both a poloidal and a toroidal current in the plasma 400, there are two such surfaces, S₁ and S₂, which have approximate characteristic sizes, Λ_{ind}≈μ₀I_{ind}/Φ and Λ_{gun}≈μ₀I_{gun}/Ψ, respectively. Λ_{gun} is related to poloidal current drive, while Λ_{ind} is related to toroidal current drive which is not present (Λ_{ind}=0) in conventional MCPG systems, see for example, T. Matsumoto et al., “Development of a magnetized coaxial plasma gun for compact toroid injection into the C-2 field-reversed configuration device”, Review of Scientific Instruments 87, 053512 (2016). It is believed that Λ_{gun}≈Λ_{ind} ≳λ may provide the optimal regime for spheromak formation due to stimulation of both poloidal and toroidal currents in the plasma 400, as well as matching the characteristic size of the spheromak 500. The high flux spheromak gun 251 employing the example magnetic flux injection schemes described below can operate around this regime.

As an aside, note that the polarities of the electrodes 254/255 dictate the clockwise +B_{φ} or counter-clockwise −B_{φ} direction of the toroidal field due to the relative directions of the current in each electrode. Analogously, the direction of bias current in each of the bias coils 252/253 dictates the parallel +B_{z} or antiparallel −B_{z} direction of the poloidal field. The directions of both toroidal and poloidal magnetic fields influence the helicity of the resultant spheromak 500 formed by the gun 251 and can be controlled by the power supply 258. Hence, gun 251 can form and eject spheromaks with left or right-handed helicities as desired. For example, to change the handedness of resultant spheromaks, power supply 258 can reverse the direction of the bias currents through the bias coils 252/253 while keeping the polarities of the electrodes 254/255 fixed. In practice, this is usually preferable to reversing the polarity of the electrodes 254/255 due to the grounding conditions on the power supply 258.

### Examples of Magnetic Flux Injection Schemes

FIGS. 6A and 6B show examples of magnetic flux injection schemes 610 that can be performed by a high flux spheromak gun. For example, the high flux spheromak gun 251 outlined in FIGS. 3, 4A, 4B, 5A and 5B with an appropriately programmed controller 270 and/or power supply 258 can perform the example magnetic flux injection schemes 610. Considering FIG. 1B, the linkage of toroidal flux Φ and poloidal flux Ψ in the gun 251 imbues the plasma with net magnetic helicity K≠0. As a consequence, the plasma quickly relaxes to a spheromak (e.g., the spheromak 500 of FIG. 1A) upon ejection from the gun 251. Spheromak gun 251 generally aims to maximize helicity injection into the plasma as this directly corresponds to increased magnetic flux and magnetic energy of the resulting spheromak.

Due to global conservation of magnetic helicity, the rate of change in the plasma helicity K follows a balance equation describing formation and sustainment of the spheromak. The helicity balance equation can be approximated as:

$$\frac{d K}{d T} \approx - \frac{1}{τ} K + \frac{d ( 2 Φ Ψ )}{dt} = - \frac{1}{τ} K + 2 {V}_{g u n} Ψ + 2 {V}_{i n d} Φ$$

τ=μ₀σ/(2λ²) is the (approximate) resistive decay time of the spheromak discussed previously. K/τ is the helicity dissipation rate of the plasma and d(2ΦΨ)/dt is the helicity injection rate into the plasma by the gun 251. V_{gun}=\dot{Φ}≈Lİ_{gun} corresponds to the toroidal flux injection rate from the electrodes 254/255 and

$${V}_{i n d} = \dot{Ψ} \approx \frac{{L}_{o u t}}{{N}_{o u t}} {\dot{I}}_{o u t} + \frac{{L}_{i n}}{{N}_{i n}} {\dot{I}}_{i n}$$

corresponds to the poloidal flux injection rate from the bias coils 252/253.

In general, the high flux gun 251 varies both the toroidal flux Φ and the poloidal flux Ψ during spheromak formation to drive poloidal (e.g., radial) and toroidal currents in the plasma simultaneously. Simultaneous poloidal and toroidal current drives can provide greater helicity injection than either alone. 2V_{gun} Ψ injects helicity through poloidal current drive, that is, V_{gun} drives a poloidal (e.g., radial) current Jₚₒₗ through the plasma that captures the poloidal magnetic flux Ψ. Analogously, 2V_{ind}Φ injects helicity through toroidal current drive, that is, Iₒᵤₜ and/or Iᵢₙ induces a toroidal current Jₜₒᵣ in the plasma that captures the toroidal magnetic flux Φ. In this way, the spheromak gun 251 can guide the magnetic configuration of the plasma toward the Taylor minimum energy state ∇×B=λB=μ₀J as a spheromak generally exhibits both toroidal and poloidal currents J=Jₜₒᵣ+Jₚₒₗ, with corresponding internal magnetic fields Bₜₒᵣ=μ₀Jₜₒᵣ/λ and Bₚₒₗ=μ₀Jₚₒₗ/λ. For example, since magnetic reconnection generally involves some form of magnetic flux and/or energy loss of the plasma (e.g., toroidal magnetic fields converting to poloidal magnetic fields and/or vice versa), the spheromak gun 251 can reduce these loss mechanisms by stimulating both Jₜₒᵣ and Jₚₒₗ simultaneously in a controlled manner.

The duration of the spheromak formation process can be comparable to the lifetime of the spheromak t, e.g., about 100 μs or more. This slow formation process can facilitate significant helicity injection since spheromaks are relatively long-lived. For example, in steady-state spheromak sustainment \dot{K}≈0, the helicity dissipation rate is balanced by the helicity injection rate:

$$K \approx 2 τ {V}_{g u n} Ψ + 2 τ {V}_{i n d} Φ$$

As the duration of spheromak formation increases with longer lifetimes τ→∞, the injected helicity increases proportionally K→∞. Examples of high magnetic flux injection schemes that implement relatively slow spheromak formation processes are described below.

Note, although examples of slow spheromak formation processes having time scales of about 100 μs are described in detail, the spheromak guns disclosed herein are not limited to such. For example, the high flux spheromak gun 251 can also be operated at shorter time scales of about 50 μs or less (e.g., about 40 μs or less, about 30 μs or less, about 20 μs or less, about 10 μs or less). As explained above, the various design parameters of the spheromak gun 251 such as the control sequence performed by the controller 270, the geometry of the electrodes 254/255, the geometry of the bias coils 252/253, the levels of voltage and/or current provided by the power supply 258, the presence or absence of a ferromagnetic-core 261, the amount and/or pressure of gas injected by the one or more gas-puff valves 256, the overall size of the gun 151, etc. can all be modified for a desired implementation.

FIG. 6A is an example of a magnetic flux injection scheme 610A that can be performed by a high flux spheromak gun to generate high flux spheromak plasma configurations. For example, the high flux spheromak gun 251 described with respect to FIGS. 3, 4A, 4B, 5A and 5B can perform the magnetic flux injection scheme 610A to generate spheromak plasmas having toroidal and/or poloidal magnetic fluxes of about 30 mWb. The example magnetic flux injection scheme 610A proceeds as follows:

At t<<−t₀, a steady-state poloidal magnetic flux Ψ=Ψ₀ of about 30 mWb is generated by (at least one of) the bias coils which is maintained for the duration of the process. The steady-state poloidal flux 4′, provides an equilibrium flux for poloidal current drive.

At t=−t₀≈−20 μs, the plasma is generated between the electrodes by the power supply. For example, the power supply can ionize an injected gas using a high-voltage discharge across the electrodes. Immediately following plasma generation, a transient toroidal flux Φ=ΔΦ(t) is generated by the electrodes with a rise time of about 20 μs and a peak value of about 10 mWb. This corresponds to a gun voltage of V_{gun}=Δ\dot{φ}≈Lİ_{gun}≈500 V which increases the plasma current Iₚ due to the poloidal (e.g., radial) current driven through the plasma. The plasma current increases to a peak value of Iₚ≈I_{gun}≈50 kA before leveling off. Thus, poloidal current drive injects helicity at a rate of 2V_{gun} Ψ₀≈30 Wb²/s.

At t=0, the rate of change of the plasma current due to poloidal current drive is about zero İₚ≈0. Subsequently, a transient poloidal magnetic flux Ψ=Ψ₀+ΔΨ(t) is generated by (at least one of) the bias coils with a rise time of about 100 μs and a peak value of ~30 mWb. The transient poloidal flux ΔΨ(t) corresponds to an induced voltage of V_{ind}=Δ\dot{Ψ}≈300 V. The large swing in the poloidal flux Ψ increases the plasma current Iₚ substantially due to the induced toroidal current. The plasma current increases to a peak value of Iₚ≈I_{gun}+I_{ind}≈200 kA. While ΔΨ is increasing, the toroidal flux ΔΦ is crowbarred by the power supply (causing slight oscillations) to maintain the poloidal current I_{gun} and hold the toroidal flux @ roughly constant near the peak value of ~10 mWb. Consequently, toroidal current drive injects helicity at a rate of 2ΦV_{ind}≈6 Wb²/s.

The average injected helicity from both poloidal and toroidal current drive is approximately

$$K \approx 30 \frac{{Wb}^{2}}{s} \times 20 μs + 6 \frac{{Wb}^{2}}{s} \times 100 μs = 600 {mWb}^{2} + 600 {mWb}^{2} = 1200 {mWb}^{2}$$

which is double than from any one source. The average injected poloidal and toroidal magnetic flux may be approximated as \sqrt{K/2}≈25 mWb. Accordingly, a high flux spheromak plasma is formed and undesirable effects such as electrode impurity injection can be avoided since the current through the electrodes is modest ~50 kA. Even higher flux spheromaks can be generated by increasing the current through the electrodes and/or the bias coils.

FIG. 6B is another example of a magnetic flux injection scheme 610B that can be performed by a high flux spheromak gun to can generate high flux spheromak plasma configurations. For example, the high flux spheromak gun 251 described with respect to FIGS. 3, 4A, 4B, 5A and 5B can perform the magnetic flux injection scheme 610B to generate spheromak plasmas having toroidal and/or poloidal magnetic fluxes of about 30 mWb. The flux injection scheme 610B of FIG. 6B follows similar steps to the flux injection scheme 610A of FIG. 6A. However, in this case, there is a fast reversal of the transient poloidal magnetic flux ΔΨ from positive to negative values around t=75 μs. The fast reversal of poloidal flux can be useful to increase the induced toroidal current in the plasma

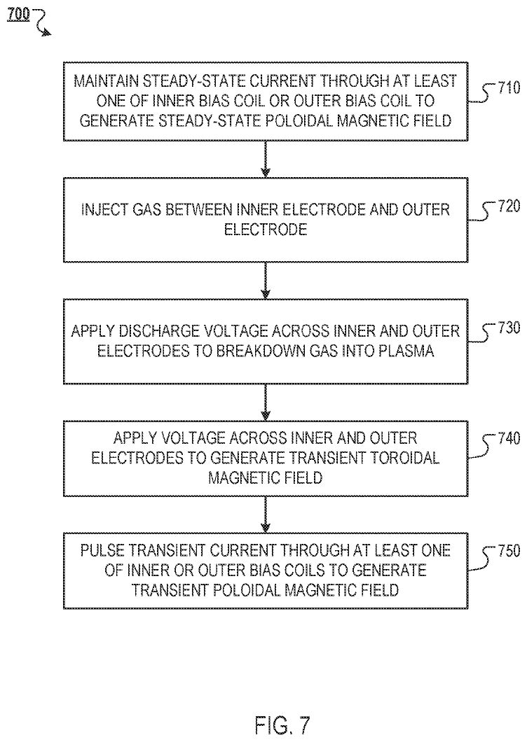

FIG. 7 is a flow diagram of an example process 700 for forming a plasma having a spheromak configuration. The process 700 describes the procedure for varying voltages across the electrodes and bias currents through the bias coils of a spheromak gun to form the spheromak configuration. Voltages and currents are generally the parameters that can be directly monitored and controlled by a power supply and/or an appropriately programmed electronic controller. The magnetic fields and fluxes manifest from these parameters and can be difficult to measure in practice. For convenience, the process 700 will be described as being performed by an electronic controller of a spheromak gun (e.g., the spheromak gun 250 or 251 of FIG. 2 or 3, respectively). The controller can be an external or internal component of the power supply depending on the implementation.

Controller maintains, using the power supply, a steady-state bias current through at least one of an inner bias coil or an outer bias coil to generate a steady-state poloidal magnetic field (710). The steady-state poloidal field establishes a steady-state poloidal flux Ψ% for poloidal current drive. The power supply can maintain the steady-state bias current throughout the duration of the process 700 or until helicity is injected via poloidal current drive.

Controller injects, using one or more gas-puff valves, a gas between an outer electrode and an inner electrode (720). The gas can be a neutral gas, a pre-ionized gas, a hydrogen gas, a deuterium gas, a tritium gas, etc. as mentioned previously. Multiple gas-puff valves (e.g., 2, 3, 4 or more gas-puff valves) generally provide a more even dispersion of gas between the electrodes than a single gas-puff valve.

Controller applies, using the power supply, a discharge voltage V_{dis} across the inner and outer electrodes to breakdown the gas into the plasma (730). For example, the discharge voltage can ionize the gas into the plasma.

Controller applies, using the power supply, a (gun) voltage V_{gun} across the inner and outer electrodes to generate a transient toroidal magnetic field Bₜₒᵣ (740). The (gun) voltage drives a radial current through the plasma that is conducted through the inner and outer electrodes, thereby generating the transient toroidal magnetic field. The transient toroidal magnetic field is associated with a transient toroidal magnetic flux Δφ=V_{gun}, injecting helicity into the plasma through poloidal current drive 2V_{gun} Ψ₀.

Controller pulses, using the power supply, a transient bias current through at least one of the inner or outer bias coils to generate a transient poloidal magnetic field (750). The transient poloidal magnetic field induces a toroidal current in the plasma. The transient poloidal magnetic field is associated with a transient poloidal magnetic flux Δ\dot{Ψ}=V_{ind}, injecting helicity into the plasma through toroidal current drive 2V_{ind}φ.

In some implementations, controller uses the power supply to maintain the steady-state bias current through one of the inner or outer bias coils (step 710) and pulse the transient bias current through the other bias coil (step 750). In other implementations, controller uses the power supply to maintain the steady-state bias current (step 710) and pulse the transient bias current (step 750) through only one of the inner or outer bias coils. In yet other implementations, controller uses the power supply to maintain a respective steady-state bias current (step 710) and pulse a respective transient bias current (step 750) through both of the inner and outer bias coils, where the respective steady-state bias current and/or the respective transient bias current can be the same or different for either bias coil. In further implementations, controller monitors the current through the inner and outer electrodes to determine appropriate waveforms and pulse timings of the transient bias currents through the inner and outer bias coils. For example, controller can determine that the rate of change of the radial current driven through the plasma is below a threshold value (e.g., approximately zero), corresponding to a peak radial current. In response, controller can pulse the transient bias current through at least one of the inner or outer bias coils which will induce the toroidal current in the plasma, thereby increasing the plasma current beyond the peak radial current.

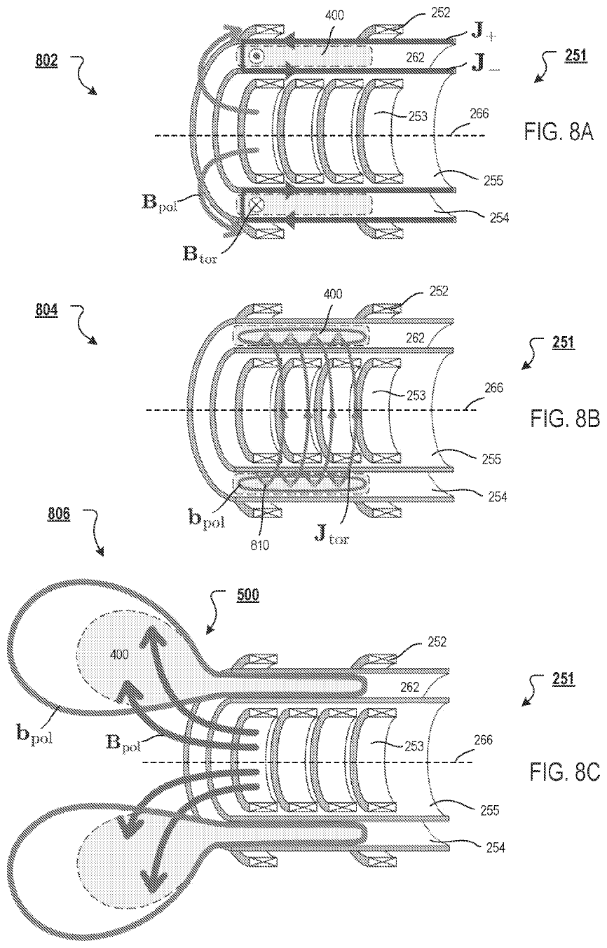

FIGS. 8A-8C show stages 802-806 of an example spheromak formation process during operation of a high flux spheromak gun, e.g., the high flux spheromak gun 251 depicted in FIGS. 3, 4A, 4B, 5A and 5B. Stages 802-806 outline how the magnetic configuration of a plasma can be guided towards the Taylor minimum energy state during the magnetic flux injection schemes 610 described above. In general, the stages 802-806 of the spheromak formation process proceed as follows:

Initially, power supply 258 applies a steady-state current to outer bias coil 252 and/or inner bias coil 253 to generate a steady-state poloidal magnetic field Bₚₒₗ. The steady-state poloidal field corresponds to a final equilibrium poloidal field of the spheromak plasma.

Stage (802): A plasma discharge 400 is drawn between outer electrode 254 and inner electrode 255. Subsequently, a toroidal magnetic flux is generated in the plasma 400 due to a transient toroidal magnetic field Bₜₒᵣ. The toroidal field Bₜₒᵣ is generated by current J_{±} conducted through the electrodes 254/255 and the plasma 400.

Stage (804): Power supply 258 pulses a transient bias current into at least one of the bias coils 252/253 to generate a transient poloidal magnetic field. This induces a toroidal current Jₜₒᵣ in the plasma 400 which generates a corresponding induced poloidal magnetic field bₚₒₗ. Here, the superposition of the steady-state poloidal field and the induced poloidal field (Bₚₒₗ+bₚₒₗ) creates a poloidal field minimum 810 in the central region (null-line region) of the cavity 262 between the electrodes 254/255. Increasing toroidal current Jₜₒᵣ in the null-line region of plasma 400 generates the plasma 400's poloidal flux in a toroidally concentric region surrounding the inner electrode 255.

Stage (806): The toroidal field Bₜₒᵣ distends the plasma, stretching it toward the central axis 266 where the poloidal field is weaker. Simultaneously, the bias current in at least one of the bias coils 252/253 (e.g., inner bias coil 253) is reduced to increase the toroidal current Jₜₒᵣ in the plasma 400. Magnetic reconnection of the induced poloidal field bₚₒₗ occurs and a plasma toroid, the desired spheromak 500 configuration, is created and ejected from the gun 251.

### Examples of FRC Confinement Systems

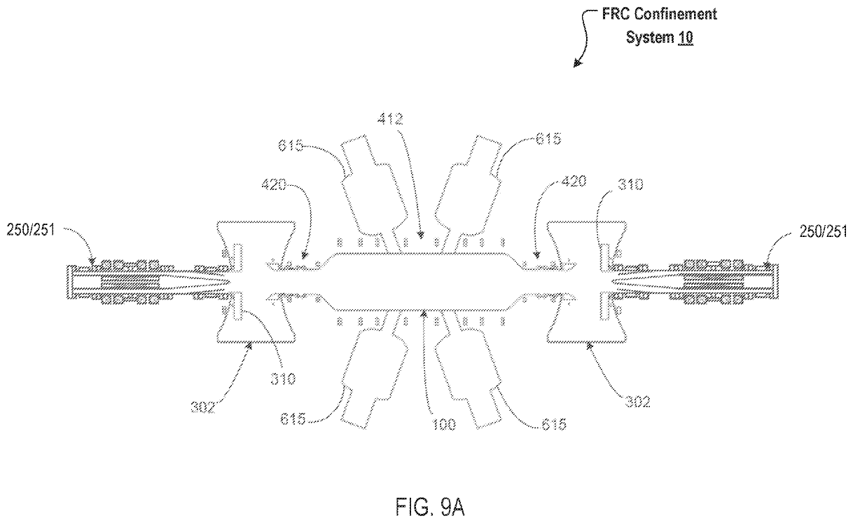

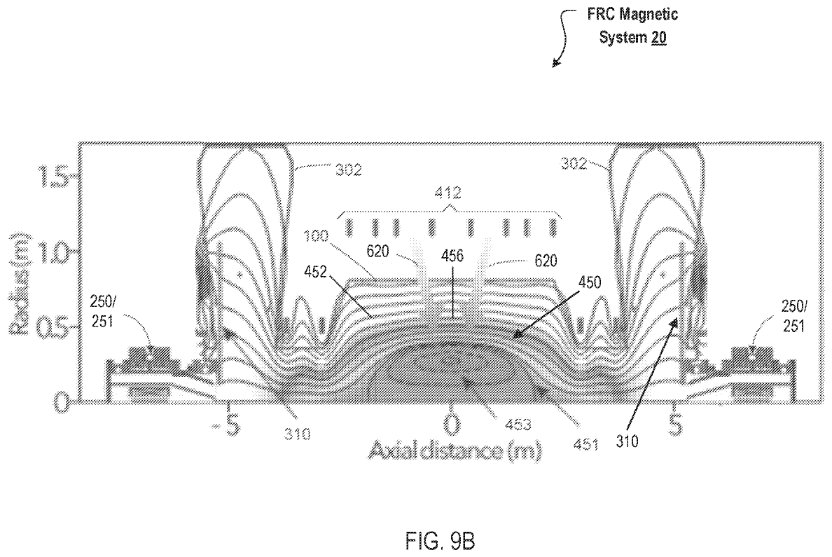

FIG. 9A shows an example of a FRC confinement system 10 that can perform spheromak counter-helicity merging and axial refueling using a pair of spheromak guns, e.g., two of the spheromak gun 250 shown in FIG. 2 or two of the high flux spheromak gun 251 shown in FIG. 3. FIG. 9B shows an example of a spheromak merging FRC magnetic system 20. Amongst other features, the FRC magnetic system 20 illustrates FRC magnetic flux and density contours (as functions of the radial and axial coordinates) pertaining to an FRC 450 producible by the example FRC system 10 shown in FIG. 9A. These contours were obtained by a two-dimensional (2-D) resistive Hall magnetohydrodynamic (MHD) numerical simulation using code developed to simulate systems, devices and methods corresponding to the FRC system 10, which agree well with measured experimental data. As seen in FIG. 9B, the FRC 450 includes a torus of closed field lines at an interior 453 of the FRC 450 inside a separatrix 451, and an annular edge layer 456 on open-field lines 452 just outside the separatrix 451.

Referring to FIG. 9A, the FRC system 10 includes a confinement chamber 100 and a pair of divertors 302 coupled to the confinement chamber 100 on each end. In order to generate an optimum initial high-flux target FRC plasma, a pair of spheromak guns 250/251 are opposingly coupled to the ends of the centrally positioned confinement chamber 100. The spheromak guns 250/251 inject high magnetic flux spheromak plasmas toward the midplane of the confinement chamber 100 where the spheromaks merge and form the FRC plasma 450. As outlined above in FIG. 1A, a spheromak is a toroidal shaped plasma in which force-free currents establish an equilibrium configuration depending on whether there is a current (flux) hole at the major axis. Two spheromak-type plasma toroids can be merge through contacting and reconnecting the toroids along a toroidally symmetric line. The two toroidal spheromaks, carrying equal toroidal current with equal or opposite toroidal magnetic field, can be forced to merge by controlled external coil currents of the FRC system 10; these are referred to as co-helicity or counter-helicity merging, respectively. The counter-helicity merging of two spheromaks tends to generate large magnetic flux target FRC plasmas with an elevated trapped-magnetic-flux.

Multiple neutral beam injectors 615 are also coupled to the confinement chamber 100 at an angle toward the midplane of the confinement chamber 100 to drive and maintain the FRC plasma 450 by neutral-beam injection (NBI). In some implementations, the neutral beam injectors 615 are adjustable from an initial power level to an increased power level. In further implementations, the spheromak guns 250/251 are capable of multi-pulsed spheromak injection into the FRC plasma 450 along the geometrical axis of the confinement chamber 100 for effective refueling and refluxing. In order to sufficiently refuel particles as well as reflux already formed FRC 450 inside the confinement chamber 100, the spheromak guns 250/251 can be powered with individually controlled power supplies.

The spheromak guns 250/251 are placed just inside the divertor 302's concentric electrodes 310 that are used for FRC 450 stability control via edge-biasing. The edge-biasing system creates a radial electric field Eᵣ on open-field lines 452, thus producing an azimuthal flow of energy by Eᵣ×B_{z} around the FRC separatrix 451 (scrape-off layer region) that stabilizes the global MHD modes, synergistically with NBI. The spheromak guns 250/251 can be operated and controlled individually to produce various spheromak plasmas as well as the initial FRC, which allows the initial plasma density and trapped-magnetic-flux to be varied to find an optimum target FRC for effective NBI. During the process of spheromak formation, translation and merging, relatively low equilibrium and mirror fields (Bₑ~1 kG, mirror ratio of ~2) in the confinement chamber 100 are applied by equilibrium coils 412 and mirror coils 420 so that FRC plasma 450 can be adequately formed. After which, the fields can be gradually increased (Bₑ up to 3 kG, mirror ratio of ~3-3.5) to confine and sustain the FRC plasma 450. Neutral beams 620 are also injected into the confinement chamber 100 from the neutral beam injectors 615 throughout the discharge, and the beam energy can also be increased from an initial to an elevated power level, e.g., ~15 keV to 40 keV, together with Bₑ ramp-up, accordingly. Furthermore, the magnets and neutral beam injector system can be actively controlled to stabilize and maintain the FRC plasma 450 in real-time.

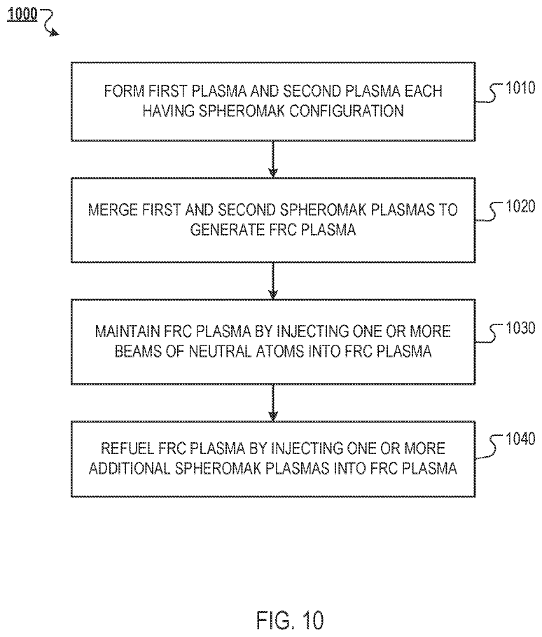

FIG. 10 is a flow diagram of an example process 1000 for the formation of high trapped-magnetic-flux FRC plasmas by merging two spheromaks with opposite helicities.

The example process 1000 for FRC formation includes:
Forming two spheromak plasmas using opposingly coupled spheromak guns (1010), where each spheromak plasma is formed according to the process (700);
Generating a large trapped-magnetic-flux target FRC plasma via counter-helicity spheromak merging of the two spheromak plasma (1020);
Amplifying, stabilizing, and powering the FRC plasma up toward fusion reactor plasma conditions by forming a target plasma with sufficient magnetic flux and injecting high-energy neutral beams, thus converting the beam energy further to thermal energy (1030);
Forming and injecting additional multi-pulsed spheromaks into the FRC plasma for particle refueling and refluxing in order to sustain and enhance the FRC plasma confinement properties as well as to achieve a high-flux and dense FRC regime (1040).

Examples of the abovementioned FRC confinement systems and further configurations are described in Int'l. Appl. No. PCT/US2021/013295, filed Jan. 13, 2021 and titled System and Methods for Forming and Maintaining High Energy and Temperature FRC Plasma via Spheromak Merging and Neutral Beam Injection, which is incorporated by reference herein in its entirety for all purposes.

Various aspects of the present subject matter are set forth below, in review of, and/or in supplementation to, the examples described thus far, with the emphasis here being on the interrelation and interchangeability of the following embodiments and the aspects thereof. In other words, an emphasis is on the fact that each aspect of the embodiments can be combined with each and every other aspect unless explicitly stated or taught otherwise.

In a first group of embodiments, a spheromak gun is provided. The spheromak gun includes multiple axisymmetric elements sharing a central axis. The elements include: a first electrode; a second electrode positioned about the first electrode, where the first and second electrodes are configured to conduct current parallel to the central axis to generate toroidal magnetic fields; a first coil positioned within the first electrode; and a second coil positioned about the second electrode, where the first and second coils are configured to conduct current azimuthally about the central axis to generate poloidal magnetic fields. The spheromak gun further includes a power supply electrically connected to the elements, where the power supply is programmed, during use of the spheromak gun, to: maintain a first current through at least one of the first or second coils to generate a first poloidal magnetic field; generate a plasma between the first and second electrodes; apply a first voltage across the first and second electrodes to generate a first toroidal magnetic field, where the first voltage drives a radial current through the plasma; and pulse a second current through at least one of the first or second coils to generate a second poloidal magnetic field, where the second poloidal magnetic field induces a toroidal current in the plasma.

In some embodiments of the first group, the first toroidal magnetic field accelerates the plasma parallel to the central axis by a Lorentz force on the radial current. The Lorentz force can accelerate the plasma to a speed of 100 kilometers per second (km/s) or more.

In some embodiments of the first group, the first poloidal magnetic field is a steady-state poloidal magnetic field.

In some embodiments of the first group, applying the first voltage across the first and second electrodes includes a rise of the first toroidal magnetic field followed by a crowbarring of the first toroidal magnetic field. The first toroidal magnetic field can have a rise time of 10 microseconds (μs) or more.

In some embodiments of the first group, pulsing the second current through at least one of the first or second coils includes: determining that a rate of change of the radial current driven through the plasma is below a threshold value, and in response, pulsing the second current through at least one of the first or second coils.

In some embodiments of the first group, pulsing the second current through at least one of the first or second coils includes a rise of the second poloidal magnetic field. The second poloidal magnetic field can have a rise time of 50 μs or more. Pulsing the second current through at least one of the first or second coils can further include a reversal of the second poloidal magnetic field.

In some embodiments of the first group, the first current is maintained through the first coil and the second current is pulsed through the second coil, or the first current is maintained through the second coil and the second current is pulsed through the first coil.

In some embodiments of the first group, the first poloidal magnetic field corresponds to a peak poloidal magnetic flux of 20 milliwebers (mWb) or more.

In some embodiments of the first group, the first toroidal magnetic field corresponds to a peak toroidal magnetic flux of 10 mWb or more.

In some embodiments of the first group, the second poloidal magnetic field corresponds to a peak poloidal magnetic flux of 20 mWb or more.

In some embodiments of the first group, the plasma has a temperature of 10 electronvolts (eV) or more.

In some embodiments of the first group, the spheromak gun further includes one or more gas-puff valves disposed on a periphery of the elements and configured to inject a gas between the first and second electrodes. Generating the plasma between the first and second electrodes can include: injecting, by the one or more gas-puff valves, the gas between the first and second electrodes; and applying, by the power supply, a discharge voltage across the first and second electrodes to breakdown the gas into the plasma. The one or more gas-puff valves can be arranged tangentially about the elements. Each of the one or more gas-puff valves can be a solenoid valve. The gas can have a pressure of 40 pounds per square inch absolute (psia) or more. The gas can include at least one of a hydrogen gas, a deuterium gas, a helium-3 gas, or a tritium gas.

In some embodiments of the first group, current conducted through either of the first or second electrodes has a peak value in a range from 100 kiloamps (kA) to 300 kA.

In some embodiments of the first group, current conducted through either of the first or second coils has a peak value in a range from 10 kA to 15 kA.

In some embodiments of the first group, the power supply executes its programming in a duration of 100 μs or more.

In some embodiments of the first group, the spheromak gun further includes a first insulator between the first electrode and the first coil, where the first insulator thermally isolates the first electrode from the first coil. The first insulator can include at least one of vacuum or ceramic.

In some embodiments of the first group, the spheromak gun further includes a second insulator between the second electrode and the second coil, where the second insulator thermally isolates the second electrode from the second coil. The second insulator can include at least one of vacuum or ceramic.

In some embodiments of the first group, the spheromak gun further includes a third insulator electrically isolating the first and second electrodes. The third insulator can include ceramic.

In some embodiments of the first group, the spheromak gun further includes a shunt inductor electrically connected between the first and second electrodes. The shunt inductor can have an inductance in a range from 10 microhenry (μH) to 50 μH.

In some embodiments of the first group, the first electrode has an outer radius in a range from 10 centimeters (cm) to 20 cm.

In some embodiments of the first group, the second electrode has an inner radius in a range from 15 cm to 30 cm.

In some embodiments of the first group, the first and second electrodes have respective lengths in a range from 100 cm to 200 cm.

In some embodiments of the first group, the first and second electrodes have respective thicknesses in a range from 1 millimeter (mm) to 10 mm.

In some embodiments of the first group, the first and electrodes each include a linear slit parallel to the central axis.

In some embodiments of the first group, the first electrode is a cathode and the second electrode is an anode. The anode can be grounded.

In Ir some embodiments of the first group, the first and second electrodes include stainless steel. The stainless steel can be SS 304L.

In some embodiments of the first group, the elements further include a head attachable to the first electrode and configured to extend the first electrode. The head can include tungsten. The head can have a hemispherical shape.

In some embodiments of the first group, at least one of the first or second electrodes has a tungsten coating. The tungsten coating can be applied with a Vacuum Plasma Spraying technique. The tungsten coating can have a thickness in a range from 0.1 μm to 0.5 μm.

In some embodiments of the first group, the first and second coils each include 10 turns to 30 turns.

In some embodiments of the first group, the first and second coils have respective lengths in a range from 30 cm to 150 cm.

In some embodiments of the first group, the first coil includes a ferromagnetic-core having a relative magnetic permeability greater than 1. The ferromagnetic-core can be an iron-core. The iron-core can include cast iron and the relative magnetic permeability can be 250 or more. The iron-core can include 99.9% iron or more and the relative magnetic permeability can be 200,000 or more.

In a second group of embodiments, a field-reversed configuration (FRC) confinement system is provided. The FRC confinement system includes: a confinement chamber configured to support an FRC plasma; and two spheromak guns opposingly coupled to the confinement chamber to form the FRC plasma via spheromak plasma merging, where each spheromak gun is configured in accordance with any of the embodiments of the first group.

In some embodiments of the second group, during use of the FRC confinement system, the FRC plasma has a trapped-magnetic-flux of 30 mWb or more.

In a third group of embodiments, a method of generating a plasma having a field-reversed configuration (FRC) is provided. The method includes: forming a first plasma and a second plasma each having a spheromak configuration, where forming each spheromak plasma includes: maintaining a first current through at least one of a first coil or a second coil to generate a first poloidal magnetic field; generating the plasma between a first electrode and a second electrode; applying a first voltage across the first and second electrodes to generate a first toroidal magnetic field, where the first voltage drives a radial current through the plasma; and pulsing a second current through at least one of the first or second coils to generate a second poloidal magnetic field, where the second poloidal magnetic field induces a toroidal current in the plasma; and merging the first and second spheromak plasmas to generate the FRC plasma.

In some embodiments of the third group, the first and second spheromak plasmas have opposite helicities.

In some embodiments of the third group, the FRC plasma has a trapped-magnetic-flux of 30 mWb or more.

In some embodiments of the third group, the method further includes: maintaining the FRC plasma by injecting one or more beams of neutral atoms into the FRC plasma.

In some embodiments of the third group, the method further includes: refueling the FRC plasma by injecting one or more additional spheromak plasmas into the FRC plasma.

In some embodiments of the third group, generating the plasma between the first and second electrodes includes: injecting a gas between the first and second electrodes; and applying a discharge voltage across the first and second electrodes to breakdown the gas into the plasma.

In some embodiments of the third group, the first poloidal magnetic field is a steady-state poloidal magnetic field.

In some embodiments of the third group, applying the first voltage across the first and second electrodes includes a rise of the first toroidal magnetic field followed by a crowbarring of the first toroidal magnetic field. The first toroidal magnetic field can have a rise time of 10 μs or more.

In some embodiments of the third group, pulsing the second current through at least one of the first or second coils includes: determining that a rate of change of the radial current driven through the plasma is below a threshold value, and in response, pulsing the second current through at least one of the first or second coils.

In some embodiments of the third group, pulsing the second current through at least one of the first or second coils includes a rise of the second poloidal magnetic field. The second poloidal magnetic field can have a rise time of 50 μs or more. Pulsing the second current through at least one of the first or second coils can further include a reversal of the second poloidal magnetic field.

In some embodiments of the third group, the first current is maintained through the first coil and the second current is pulsed through the second coil, or the first current is maintained through the second coil and the second current is pulsed through the first coil.

In some embodiments of the third group, the method has a duration of 100 μs or more.

In a fourth group of embodiments, a method of forming a plasma having a spheromak configuration is provided. The method includes: maintaining a first current through at least one of a first coil or a second coil to generate a first poloidal magnetic field; generating the plasma between a first electrode and a second electrode; applying a first voltage across the first and second electrodes to generate a first toroidal magnetic field, where the first voltage drives a radial current through the plasma; and pulsing a second current through at least one of the first or second coils to generate a second poloidal magnetic field, where the second poloidal magnetic field induces a toroidal current in the plasma.

To the extent the examples disclosed herein include or operate in association with memory, storage, and/or computer readable media, then that memory, storage, and/or computer readable media are non-transitory. Accordingly, to the extent that memory, storage, and/or computer readable media are covered by one or more claims, then that memory, storage, and/or computer readable media is only non-transitory.

As used herein and in the appended claims, the singular forms “a,” “an,” and “the” include plural referents unless the context clearly dictates otherwise.

While the examples are susceptible to various modifications and alternative forms, specific examples thereof have been shown in the drawings and are herein described in detail. It should be understood, however, that these examples are not to be limited to the particular form disclosed, but to the contrary, these examples are to cover all modifications, equivalents, and alternatives falling within the spirit of the disclosure. Furthermore, any features, functions, steps, or elements of the examples may be recited in or added to the claims, as well as negative limitations that define the inventive scope of the claims by features, functions, steps, or elements that are not within that scope.

What is claimed is:

1. A spheromak gun, comprising:
a plurality of axisymmetric elements sharing a central axis, the elements comprising:
a first electrode;
a second electrode positioned about the first electrode,
wherein the first and second electrodes are configured to conduct current parallel to the central axis to generate toroidal magnetic fields;
a first coil positioned within the first electrode; and
a second coil positioned about the second electrode,
wherein the first and second coils are configured to conduct current azimuthally about the central axis to generate poloidal magnetic fields; and
a power supply electrically connected to the elements, wherein the power supply is programmed, during use of the spheromak gun, to:
maintain a first current through at least one of the first or second coils to generate a first poloidal magnetic field;
generate a plasma between the first and second electrodes;
apply a first voltage across the first and second electrodes to generate a first toroidal magnetic field, wherein the first voltage drives a radial current through the plasma; and
pulse a second current through at least one of the first or second coils to generate a second poloidal magnetic field, wherein the second poloidal magnetic field induces a toroidal current in the plasma.

2. The spheromak gun of claim 1, wherein the first toroidal magnetic field accelerates the plasma parallel to the central axis by a Lorentz force on the radial current.

3. The spheromak gun of claim 2, wherein the Lorentz force accelerates the plasma to a speed of 100 kilometers per second (km/s) or more.

4. The spheromak gun of any preceding claim, wherein the first poloidal magnetic field is a steady-state poloidal magnetic field.

5. The spheromak gun of any preceding claim, wherein applying the first voltage across the first and second electrodes includes a rise of the first toroidal magnetic field followed by a crowbarring of the first toroidal magnetic field.

6. The spheromak gun of claim 5, wherein the first toroidal magnetic field has a rise time of 10 microseconds (μs) or more.

7. The spheromak gun of any preceding claim, wherein pulsing the second current through at least one of the first or second coils comprises:
determining that a rate of change of the radial current driven through the plasma is below a threshold value, and
in response, pulsing the second current through at least one of the first or second coils.

8. The spheromak gun of any preceding claim, wherein pulsing the second current through at least one of the first or second coils includes a rise of the second poloidal magnetic field.

9. The spheromak gun of claim 8, wherein the second poloidal magnetic field has a rise time of 50 μs or more.

10. The spheromak gun of any of claims 8-9, wherein pulsing the second current through at least one of the first or second coils further includes a reversal of the second poloidal magnetic field.

11. The spheromak gun of any preceding claim, wherein:
the first current is maintained through the first coil and the second current is pulsed through the second coil, or
the first current is maintained through the second coil and the second current is pulsed through the first coil.

12. The spheromak gun of any preceding claim, wherein the first poloidal magnetic field corresponds to a peak poloidal magnetic flux of 20 milliwebers (mWb) or more.

13. The spheromak gun of any preceding claim, wherein the first toroidal magnetic field corresponds to a peak toroidal magnetic flux of 10 mWb or more.

14. The spheromak gun of any preceding claim, wherein the second poloidal magnetic field corresponds to a peak poloidal magnetic flux of 20 mWb or more.

15. The spheromak gun of any preceding claim, wherein the plasma has a temperature of 10 electronvolts (eV) or more.

16. The spheromak gun of any preceding claim, further comprising one or more gas-puff valves disposed on a periphery of the elements and configured to inject a gas between the first and second electrodes.

17. The spheromak gun of claim 16, wherein generating the plasma between the first and second electrodes comprises:
injecting, by the one or more gas-puff valves, the gas between the first and second electrodes; and
applying, by the power supply, a discharge voltage across the first and second electrodes to breakdown the gas into the plasma.

18. The spheromak gun of any of claims 16-17, wherein the one or more gas-puff valves are arranged tangentially about the elements.

19. The spheromak gun of any of claims 16-18, wherein each of the one or more gas-puff valves is a solenoid valve.

20. The spheromak gun of any of claims 16-19, wherein the gas has a pressure of 40 pounds per square inch absolute (psia) or more.

21. The spheromak gun of any of claims 16-20, wherein the gas comprises at least one of a hydrogen gas, a deuterium gas, a helium-3 gas, or a tritium gas.

22. The spheromak gun of any preceding claim, wherein current conducted through either of the first or second electrodes has a peak value in a range from 100 kiloamps (kA) to 300 kA.

23. The spheromak gun of any preceding claim, wherein current conducted through either of the first or second coils has a peak value in a range from 10 kA to 15 kA.

24. The spheromak gun of any preceding claim, wherein the power supply executes its programming in a duration of 100 μs or more.

25. The spheromak gun of any preceding claim, further comprising a first insulator between the first electrode and the first coil, wherein the first insulator thermally isolates the first electrode from the first coil.

26. The spheromak gun of claim 25, wherein the first insulator comprises at least one of vacuum or ceramic.

27. The spheromak gun of any preceding claim, further comprising a second insulator between the second electrode and the second coil, wherein the second insulator thermally isolates the second electrode from the second coil.

28. The spheromak gun of claim 27, wherein the second insulator comprises at least one of vacuum or ceramic.

29. The spheromak gun of any preceding claim, further comprising a third insulator electrically isolating the first and second electrodes.

30. The spheromak gun of claim 29, wherein the third insulator comprises ceramic.

31. The spheromak gun of any preceding claim, further comprising a shunt inductor electrically connected between the first and second electrodes.

32. The spheromak gun of claim 31, wherein the shunt inductor has an inductance in a range from 10 microhenry (μH) to 50 μH.

33. The spheromak gun of any preceding claim, wherein the first electrode has an outer radius in a range from 10 centimeters (cm) to 20 cm.

34. The spheromak gun of any preceding claim, wherein the second electrode has an inner radius in a range from 15 cm to 30 cm.

35. The spheromak gun of any preceding claim, wherein the first and second electrodes have respective lengths in a range from 100 cm to 200 cm.

36. The spheromak gun of any preceding claim, wherein the first and second electrodes have respective thicknesses in a range from 1 millimeter (mm) to 10 mm.

37. The spheromak gun of any preceding claim, wherein the first and electrodes each comprise a linear slit parallel to the central axis.

38. The spheromak gun of any preceding claim, wherein the first electrode is a cathode and the second electrode is an anode.

39. The spheromak gun of claim 38, wherein the anode is grounded.

40. The spheromak gun of any preceding claim, wherein the first and second electrodes comprise stainless steel.

41. The spheromak gun of claim 40, wherein the stainless steel is SS 304L.

42. The spheromak gun of any preceding claim, wherein the elements further comprise a head attachable to the first electrode and configured to extend the first electrode.

43. The spheromak gun claim 42, wherein the head comprises tungsten.

44. The spheromak gun of any of claims 42-43, wherein the head has a hemispherical shape.

45. The spheromak gun of any preceding claim, wherein at least one of the first or second electrodes has a tungsten coating.

46. The spheromak gun of claim 45, wherein the tungsten coating is applied with a Vacuum Plasma Spraying technique.

47. The spheromak gun of any of claims 45-46, wherein the tungsten coating has a thickness in a range from 0.1 μm to 0.5 μm.

48. The spheromak gun of any preceding claim, wherein the first and second coils each comprise 10 turns to 30 turns.

49. The spheromak gun of any preceding claim, wherein the first and second coils have respective lengths in a range from 30 cm to 150 cm.

50. The spheromak gun of any preceding claim, wherein the first coil comprises a ferromagnetic-core having a relative magnetic permeability greater than 1.

51. The spheromak gun of claim 50, wherein the ferromagnetic-core is an iron-core.

52. The spheromak gun of claim 51, wherein the iron-core comprises cast iron and the relative magnetic permeability is 250 or more.

53. The spheromak gun of claim 51, wherein the iron-core comprises 99.9% iron or more and the relative magnetic permeability is 200,000 or more.

54. A field-reversed configuration (FRC) confinement system, comprising:
a confinement chamber configured to support an FRC plasma; and
two spheromak guns opposingly coupled to the confinement chamber to form the FRC plasma via spheromak plasma merging, wherein each spheromak gun is configured in accordance with any of claims 1-53.

55. The FRC confinement system of claim 54, wherein, during use of the FRC confinement system, the FRC plasma has a trapped-magnetic-flux of 30 mWb or more.

56. A method of generating a plasma having a field-reversed configuration (FRC), the method comprising:
forming a first plasma and a second plasma each having a spheromak configuration, wherein forming each spheromak plasma comprises:
maintaining a first current through at least one of a first coil or a second coil to generate a first poloidal magnetic field;
generating the plasma between a first electrode and a second electrode;
applying a first voltage across the first and second electrodes to generate a first toroidal magnetic field, wherein the first voltage drives a radial current through the plasma; and
pulsing a second current through at least one of the first or second coils to generate a second poloidal magnetic field, wherein the second poloidal magnetic field induces a toroidal current in the plasma; and
merging the first and second spheromak plasmas to generate the FRC plasma.

57. The method of claim 56, wherein the first and second spheromak plasmas have opposite helicities.

58. The method of any of claims 56-57, wherein the FRC plasma has a trapped-magnetic-flux of 30 mWb or more.

59. The method of any of claims 56-58, further comprising:
maintaining the FRC plasma by injecting one or more beams of neutral atoms into the FRC plasma.

60. The method of claim 59, further comprising:
refueling the FRC plasma by injecting one or more additional spheromak plasmas into the FRC plasma.

61. The method of any of claims 56-60, wherein generating the plasma between the first and second electrodes comprises:
injecting a gas between the first and second electrodes; and
applying a discharge voltage across the first and second electrodes to breakdown the gas into the plasma.

62. The method of any of claims 56-61, wherein the first poloidal magnetic field is a steady-state poloidal magnetic field.

63. The method of any of claims 56-62, wherein applying the first voltage across the first and second electrodes includes a rise of the first toroidal magnetic field followed by a crowbarring of the first toroidal magnetic field.

64. The method of claim 63, wherein the first toroidal magnetic field has a rise time of 10 μs or more.

65. The method of any of claims 56-64, wherein pulsing the second current through at least one of the first or second coils comprises:
determining that a rate of change of the radial current driven through the plasma is below a threshold value, and
in response, pulsing the second current through at least one of the first or second coils.

66. The method of any of claims 56-65, wherein pulsing the second current through at least one of the first or second coils includes a rise of the second poloidal magnetic field.

67. The method of claim 66, wherein the second poloidal magnetic field has a rise time of 50 μs or more.

68. The method of any of claims 66-67, wherein pulsing the second current through at least one of the first or second coils further includes a reversal of the second poloidal magnetic field.

69. The method of any of claims 56-68, wherein:
the first current is maintained through the first coil and the second current is pulsed through the second coil, or
the first current is maintained through the second coil and the second current is pulsed through the first coil.

70. The method of any of claims 56-69, having a duration of 100 μs or more.

71. A method of forming a plasma having a spheromak configuration, the method comprising:
maintaining a first current through at least one of a first coil or a second coil to generate a first poloidal magnetic field;
generating the plasma between a first electrode and a second electrode;
applying a first voltage across the first and second electrodes to generate a first toroidal magnetic field, wherein the first voltage drives a radial current through the plasma; and
pulsing a second current through at least one of the first or second coils to generate a second poloidal magnetic field, wherein the second poloidal magnetic field induces a toroidal current in the plasma.
